(19) United States
(12) Patent Application Publication
(10) Pub. No.: US 2024/0212952 A1
(43) Pub. Date: Jun. 27, 2024

(54) INPUT DEVICE AND ASSEMBLED DEVICE

(71) Applicant: Panasonic Intellectual Property Management Co., Ltd., Kadoma-shi, Osaka (JP)

(72) Inventors: Satoshi Yoshihara, Hyogo (JP); Takuto Abe, Osaka (JP); Hiroaki Nishiono, Osaka (JP); Kenji Shibata, Osaka (JP)

(73) Assignee: Panasonic Intellectual Property Management Co., Ltd., Kadoma-shi, Osaka (JP)

(21) Appl. No.: 18/554,682

(22) PCT Filed: Feb. 4, 2022
(86) PCT No.: PCT/JP2022/004448

§ 371 Date: Oct. 10, 2023

(30) Foreign Application Priority Data
Apr. 12, 2021 (JP) 2021-067355

(51) Int. Cl. H01H 25/04; H01H 25/06; H01H 89/00

(52) U.S. Cl. CPC H01H 25/04; H01H 25/06; H01H 89/00

(57) ABSTRACT

An input device includes a fixed electrode, a reference electrode, a switch electrode, an operating member, and a moving electrode. The moving electrode is provided for the operating member and is movable integrally with the operating member. The moving electrode includes a first connection portion and a second connection portion. Subjecting the operating member to no press operation keeps the moving electrode out of contact with the fixed electrode, the reference electrode, or the switch electrode. Subjecting the operating member to a press operation brings the first connection portion into contact with the reference electrode and then brings the second connection portion into contact with the switch electrode.

### TECHNICAL FIELD

The present disclosure generally relates to an input device and an assembled device. More particularly, the present disclosure relates to an input device that allows an operator to enter an operating command thereto and an assembled device in which the input device is built.

### BACKGROUND ART

Patent Literature 1 discloses a force detector (input device), which includes a board, four electrodes (fixed electrodes), a conductive land (reference electrode), an operating button (operating member), and a displaceable electrode (moving electrode). The four electrodes are arranged on the board at an interval of 90 degrees. The conductive land is disposed on the board to be located outside the four electrodes. The operating button is arranged to face the four electrodes and the conductive land. The displaceable electrode is provided on one side of the operating button to face the four electrodes and the conductive land. In this force detector, while no pressing force is applied to the operating button, the four electrodes and the conductive land are out of contact with the displaceable electrode. On the other hand, when pressing force is applied to the operating button, the displaceable electrode comes into contact with the conductive land to produce capacitance between the displaceable electrode and the four electrodes.

In a device for detecting the operation performed on the operating button using the capacitance produced between the displaceable electrode and the four electrodes as in the force detector of Patent Literature 1, the detection accuracy of operations is low in a range where the tilt angle of the operating button is relatively small. Thus, the force detector does not detect the operation on the operating button in such a range where the tilt angle of the operating button is relatively small but detects the operation only in a range where the tilt angle of the operating button is relatively large. That is to say, the force detector may detect the operation only when the tilt angle of the operating button falls within a narrow range.

### CITATION LIST

### Patent Literature

Patent Literature 1: JP 2002-131149 A

### SUMMARY OF INVENTION

Some types of operations, however, do not require so high detection accuracy. Such types of operations need to be detected even in a range where the tilt angle of the operating button is relatively small.

In that case, the detection accuracy of operations varies according to the tilt angle of the operating button. That is why the detector preferably has the ability to determine, when detecting some operation, whether the detection has been made in a range where the tilt angle of the operating button is relatively large (i.e., in a range where the tilt angle is equal to or greater than a predetermined tilt angle).

In view of the foregoing background, it is therefore an object of the present disclosure to provide an input device and an assembled device, both having the ability to not only detect an operation performed on an operating member even when the tilt angle of the operating member falls within a broader range but also determine whether the operation has been detected in a range where the tilt angle of the operating member is equal to or greater than a predetermined tilt angle.

An input device according to an aspect of the present disclosure includes a board, a fixed electrode, a reference electrode, a switch electrode, an operating member, a moving electrode, and a holder. The fixed electrode, the reference electrode, and the switch electrode are provided for the board. The operating member is arranged to face the board and is vertically movable and tiltable with respect to the board when subjected to a press operation. The moving electrode is provided for the operating member and is movable integrally with the operating member. The board is placed in the holder. The moving electrode includes a first connection portion and a second connection portion. The first connection portion is arranged to face the reference electrode. The second connection portion is arranged to face the switch electrode. Subjecting the operating member to no press operation keeps the moving electrode out of contact with the fixed electrode, the reference electrode, or the switch electrode. Subjecting the operating member to a press operation brings the first connection portion into contact with the reference electrode and then brings the second connection portion into contact with the switch electrode.

An assembled device according to another aspect of the present disclosure includes the input device described above, a rubber sheet, an operating button, a base, and a cover panel. The rubber sheet is disposed forward of the operating member of the input device. The operating button is disposed forward of the rubber sheet. The base has a housing recess to house the input device, the rubber sheet, and the operating button. The cover panel has an opening to expose the operating button and is attached to a front surface of the base with the input device, the rubber sheet, and the operating button housed in the housing recess.

### BRIEF DESCRIPTION OF DRAWINGS

FIG. 1 is a perspective view of an assembled device according to a first embodiment;

FIG. 2 is an exploded perspective view of the assembled device;

FIG. 3 is a cross-sectional view of the assembled device;

FIG. 4 is an exploded perspective view of an input device according to the first embodiment as viewed from in front of the input device;

FIG. 5 is an exploded perspective view of the input device as viewed from behind the input device;

FIG. 6 is a plan view of a sensor board as viewed from in front of the sensor board;

FIG. 7 is a perspective view illustrating how an operating member and a moving electrode are assembled together when viewed from the rear (behind);

FIG. 8A is a cross-sectional view illustrating a standby state of the input device;

FIG. 8B is a partially enlarged view of FIG. 8A;

FIG. 9A is a cross-sectional view illustrating a centrally pushed state of the input device;

FIG. 9B is a partially enlarged view of FIG. 9A;

FIG. 10A is a cross-sectional view illustrating a tilted state of the input device;

FIG. 10B is a partially enlarged view of FIG. 10A;

FIG. 11 is a perspective view illustrating a fulcrum of tilting, a tilt axis, and a tilt direction of the operating member of the input device in a situation where the operating member is subjected to a tilt operation;

FIG. 12 is a plan view showing a relationship between the width of divided electrodes, one side of the external shape of the operating member, and the tilt direction of the operating member in the input device;

FIG. 13 is a perspective view of an operating member according to a first variation of the first embodiment as viewed from the rear;

FIG. 14 is a perspective view of an operating member according to a second variation of the first embodiment as viewed from the rear;

FIG. 15 is a perspective view of an operating member of an input device according to a third variation of the first embodiment as viewed from the rear;

FIG. 16A is a cross-sectional view illustrating a standby state of the input device;

FIG. 16B is a cross-sectional view illustrating a centrally pushed state of the input device;

FIG. 16C is a cross-sectional view illustrating a first tilted state of the input device;

FIG. 16D is a cross-sectional view illustrating a second tilted state of the input device;

FIG. 17A illustrates how to perform a flick operation according to a fourth variation of the first embodiment;

FIG. 17B illustrates an exemplary predictive text input screen;

FIG. 17C illustrates another exemplary predictive text input screen;

FIG. 18 illustrates how to perform a rotary operation according to the fourth variation;

FIG. 19 illustrates how to perform a swipe operation according to the fourth variation;

FIG. 20 illustrates how to perform a slide operation according to the fourth variation;

FIG. 21 is a perspective view of an input device according to a second embodiment as viewed from in front of the input device;

FIG. 22 is an exploded perspective view of the input device as viewed from in front of the input device;

FIG. 23 is a plan view of a sensor board as viewed from in front of the sensor board;

FIG. 24 is a perspective view illustrating how an operating member and a moving electrode are assembled together as viewed from the rear (behind);

FIG. 25 is a cross-sectional view illustrating a standby state of the input device;

FIG. 26A is a cross-sectional view illustrating a first tilted state of the input device;

FIG. 26B is a cross-sectional view illustrating a second tilted state of the input device;

FIG. 27 is a perspective view illustrating the fulcrum of tilting and tilt axis of the operating member subjected to a tilt operation in the input device; and

FIG. 28 is a cross-sectional view illustrating a centrally pushed state of the input device.

### DESCRIPTION OF EMBODIMENTS

### (1) First Embodiment

An input device and assembled device according to an exemplary embodiment will now be described in detail with reference to the accompanying drawings. Note that the embodiments to be described below are only exemplary ones of various embodiments of the present disclosure and should not be construed as limiting. Rather, the exemplary embodiments may be readily modified in various manners depending on a design choice or any other factor without departing from a true spirit and scope of the present disclosure.

### (1-1) Assembled Device

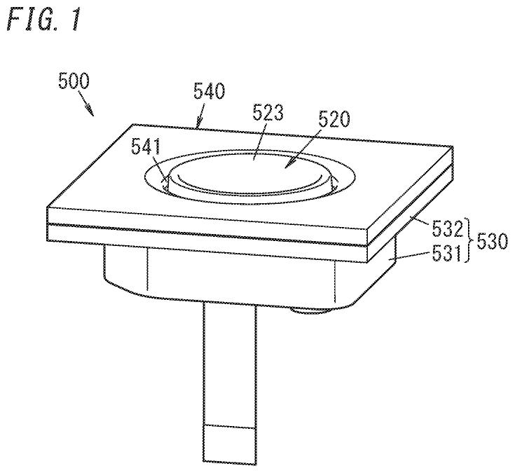

First, an assembled device 500 according to an exemplary embodiment will be described with reference to FIGS. 1-3.

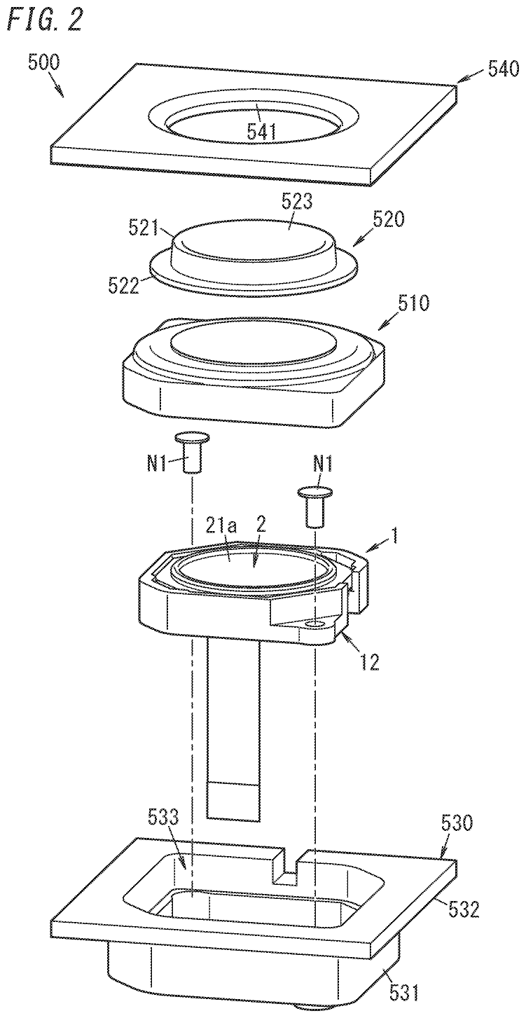

As shown in FIG. 1, the assembled device 500 is a device for accepting an operator's operating command. The assembled device 500 includes an operating button 520 and an input device 1 (refer to FIG. 2). The assembled device 500 is a device for making the input device 1 detect a press operation when the operator presses an operating surface 523 of the operating button 520 with one of his or her fingers on the outer edge or central portion thereof. The assembled device 500 may detect, for example, the press operation, a tilt operation, and other types of operations performed on the operating button 520. As used herein, the “press operation” refers to the operation of pressing down the operating button 520 and the “tilt operation” refers to the operation of tilting the operating button 520. The assembled device 500 may be mounted on, for example, a spoke portion of the steering wheel of an automobile.

As shown in FIG. 2, the assembled device 500 includes the input device 1, a rubber sheet 510, the operating button 520, a base 530, and a cover panel 540.

The base 530 is a housing that houses the input device 1, the rubber sheet 510, and the operating button 520. The base 530 includes a casing 531 and a flange portion 532. The casing 531 is a portion that houses the input device 1, the rubber sheet 510, and the operating button 520. The casing 531 may have, for example, the shape of a rectangular parallelepiped box with an opening provided through the front surface. That is to say, the casing 531 has a housing recess 533 (i.e., the internal space of the casing 531) provided through the front surface thereof to house the input device 1, the rubber sheet 510, and the operating button 520. The flange portion 532 is a part to which the cover panel 540 is attached. The flange portion 532 protrudes outward from the peripheral edge of the front surface opening of the casing 531.

The input device 1 is a device for making a capacitance sensor detect a press operation when the front surface (pressure receiving surface) 21a of the operating member 2 is pressed on the outer edge or central portion thereof. The input device 1 includes the operating member 2 and a detector 14. The operating member 2 is a part to accept an operating command. In this embodiment, an operating command is entered by an operator into the operating member 2 through the operating button 520. The operating member 2 is disposed forward of the detector 14. The detector 14 detects the displacement of the operating member 2 being operated, thereby detecting the operating command entered into the operating member 2. The input device 1 is disposed at the bottom of the housing recess 533 of the base 530 and fixed to the bottom of the housing recess 533 with screws N1.

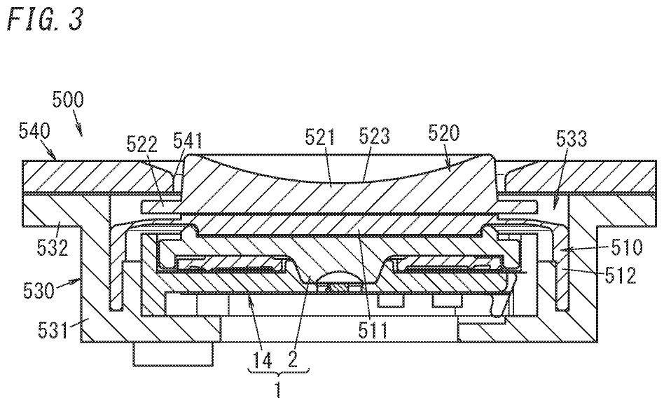

The rubber sheet 510 is a member disposed forward of the operating member 2 of the input device 1 to support the operating button 520. The rubber sheet 510 is made of an elastically deformable material (e.g., a material with rubber elasticity). The rubber sheet 510 may have, for example, the shape of a rectangular parallelepiped box with a bottom opening. The rubber sheet 510 includes a front surface portion 511 and a peripheral wall portion 512. The front surface portion 511 is a part on which the operating button 520 is disposed. The peripheral wall portion 512 protrudes backward from the peripheral edge at the rear of the front surface portion 511. The rubber sheet 510 is housed inside the housing recess 533 of the base 530 to house the input device 1 inside (refer to FIG. 3). Housing the input device 1 inside the rubber sheet 510 allows the rubber sheet 510 to be disposed forward of the operating member 2 of the input device 1. The peripheral wall portion 512 of the rubber sheet 5110 is fixed to the bottom of the housing recess 533.

The operating button 520 is a part to accept an operator's operating command. The operator may operate the operating button 520 by touching (i.e., lightly pressing) the operating button 520 with one of his or her fingers. The operating button 520 includes a button portion 521 and a flange portion 522. The button portion 521 has a dislike shape. The front surface of the button portion 521 is an operating surface 523 to be operated by the operator and may be, for example, a concave curved surface (i.e., a recessed curved surface). The flange portion 522 is a part to be caught by an edge portion on the backside of the opening 541 of the cover panel 540 (to be described later). The flange portion 522 protrudes outward from the rear edge of the outer peripheral surface of the button portion 521. The operating button 520 is housed in the housing recess 533 of the base 530 to be located forward of the front surface portion 511 of the rubber sheet 510 (refer to FIG. 3).

The cover panel 540 is a member that closes the front surface opening of the casing 531 of the base 530. The cover panel 540 is attached to the front surface of the flange portion 532 of the base 530. The cover panel 540 may have, for example, a rectangular plate shape. The cover panel 540 has an opening 541, through which the button portion 521 of the operating button 520 is exposed forward. The cover panel 540 is attached to the front side of the flange portion 532 of the base 530 with the input device 1, the rubber sheet 510, and the operating button 520 housed in the housing recess 533 of the base 530. In this state, the button portion 521 of the operating button 520 is exposed through the opening 541 of the cover panel 540.

As shown in FIG. 3, in this assembled device 500, the operating button 520 is supported by the rubber sheet 510. Thus, when the operating button 520 is pressed by the operator with one of his or her fingers, the operating button 520 is depressed into the inside of the base 530 by overcoming the elastic force of the rubber sheet 510. On the other hand, when the pressing force is removed, the operating button 520 is caused to recover its original shape (i.e., return to its rest position) under the elastic force of the rubber sheet 510. The operating member 2 of the input device 1 is displaceable integrally with the operating button 520 via the rubber sheet 510. Thus, as the operating button 520 is pressed down and depressed, the operating member 2 is also depressed integrally with the operating button 520. Meanwhile, as the operating button 520 is pressed and tilted, the operating member 2 is also tilted integrally with the operating button 520. The input device 1 detects the operating command entered through the operating button 520 by detecting the displacement (caused by depressing and tilting) of the operating member 2.

### (1-2) Details of Input Device

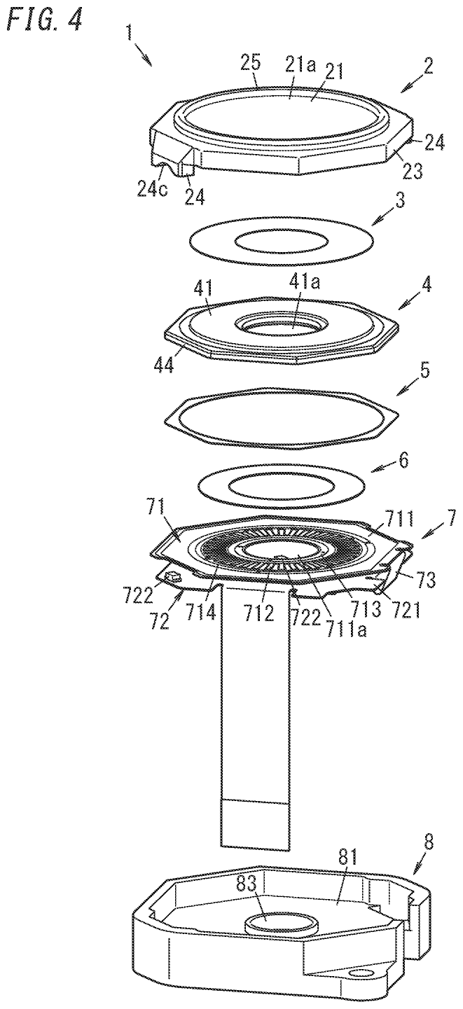

Next, the input device 1 will be described in detail with reference to FIGS. 4-12.

### (1-2-1) Configuration of Input Device

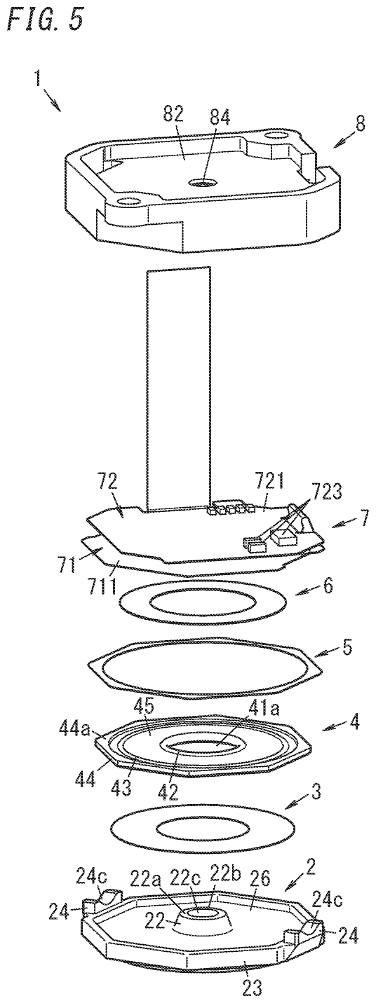

As shown in FIGS. 4 and 5, the input device 1 includes the operating member 2, a front adhesive sheet 3, the moving electrode 4, a rear adhesive sheet 5, an insulating film 6, a sensor board 7, and a holder 8. The moving electrode 4, the rear adhesive sheet 5, the insulating film 6, and the sensor board 7 together form the detector 14 described above.

### (Operating Member)

The operating member 2 is a part through which an operator's operating command is entered via the operating button 520. The operating member 2 is arranged to face a first board 711 of a sensor unit 71 (to be described later) of the sensor board 7 and is vertically movable and tiltable with respect to the first board 711 when subjected to a press operation. The operating member 2 may have, for example, the shape of a polygonal (more exactly, regular polygonal, and specifically, a regular octagonal) flat plate. The operating member 2 may be made of, for example, a colorless transparent resin.

The operating member 2 is made of a colorless transparent resin as described above, and therefore, may serve as a light guide member for guiding the light emitted from light-emitting elements 722 (to be described later) to the front surface of the operating member 2. In this embodiment, the operating button 520 and the rubber sheet 510 are transparent members. This allows the light (lighting light) emitted from the light-emitting elements 722 to be guided to the operating button 520 via the operating member 2 and the rubber sheet 510 and emerge through the operating surface 523 of the operating button 520 to make the operating surface 523 flash.

The operating member 2 includes a substrate portion 21, a protrusion (abutment portion) 22, a back surface rib 23, protrusions 24, and a front surface rib 25.

The substrate portion 21 may have, for example, the shape of a polygonal (more exactly, regular polygonal, and specifically, regular octagonal) flat plate. The back surface of the substrate portion 21 has the protrusion 22 and the back surface rib 23. On the back surface of the substrate portion 21, the area between the protrusion 22 and the back surface rib 23 is a smooth planar portion 26. This makes the moving electrode 4 closely affixable to that area (i.e., the planar portion 26) of the back surface of the substrate portion 21. The front surface of the substrate portion 21 has the front surface rib 25. The outer peripheral surface of the substrate portion 21 has the protrusions 24.

The protrusion 22 is provided in a central portion of the back surface of the substrate portion 21 (i.e., the surface facing the holder 8). The protrusion 22 may have, for example, a circular columnar shape. The top surface (rear end surface) of the protrusion 22 is a contact surface 22a to come into contact with the holder 8. The contact surface 22a may be, for example, a planar surface. When the operating member 2 tilts, the contour 22b of the contact surface 22a of the protrusion 22 will be the fulcrum of tilting of the operating member 2. The top surface (contact surface 22a) of the protrusion 22, the planar portion 26, and the top surface (rear end surface) of the back surface rib 23 are mutually parallel to each other. A central portion of the contact surface 22a of the protrusion 22 has a recess 22c. This recess 22c is an incident portion, through which the light (lighting light) emitted from the light-emitting elements 722 (to be described later) enters the operating member 2. The incident portion will be hereinafter sometimes referred to as an “incident portion 22c.”

The back surface rib 23 is provided as a ringlike portion along the peripheral edge of the back surface of the substrate portion 21. The back surface rib 23 protrudes backward with respect to the substrate portion 21 (i.e., toward the sensor board 7 (to be described later)). The back surface rib 23 is concentric with the protrusion 22. The top surface (rear end surface) of the back surface rib 23 may be, for example, a flat surface.

The protrusions 24 are provided for the outer peripheral surface of the substrate portion 21 to protrude backward with respect to the substrate portion 21. Two protrusions 24 are provided on the outer peripheral surface of the substrate portion 21 to be symmetric to each other with respect to the center of the back surface of the substrate portion 21. The rear end surface of each of these protrusions 24 has a recess 24c. This recess 24c is an incident portion, through which the light (lighting light) emitted from the light-emitting element 722 (to be described later) enters the operating member 2. The incident portion will be hereinafter sometimes referred to as an “incident portion 24c.”

The front surface rib 25 is provided for the front surface of the substrate portion 21. More specifically, the front surface rib 25 is provided inside of the outer peripheral edge of the front surface of the substrate portion 21. The front surface rib 25 is concentric with each of the back surface rib 23 and the protrusion 22. The front surface rib 25 protrudes forward with respect to the substrate portion 21. The area 21a, located inside the front surface rib 25, of the front surface of the substrate portion 21 serves not only as a pressure receiving surface, through which the operating force applied by the operator via the operating button 520 is received, but also as an emerging surface through which the light (lighting light) incident on the light incident portions 22c, 24c emerges. The pressure receiving surface will be hereinafter sometimes referred to as a “pressure receiving surface 21a.”

### (Moving Electrode)

The moving electrode 4 is an electrode that moves (i.e., is displaced) integrally with the operating member 2. The moving electrode 4 is made of an elastic material with electrical conductivity (such as conductive elastomer or conductive rubber). The front surface of the moving electrode 4 is fixed onto the back surface of the operating member 2 (i.e., the back surface of the substrate portion 21) via the front adhesive sheet 3.

The moving electrode 4 includes a substrate portion 41, the first connection portion 42, the second connection portion 43, a flexible portion 44, and a planar portion 45. The substrate portion 41 has the shape of a polygonal (e.g., regular octagonal) plate, which is similar to the external shape of the operating member 2. The substrate portion 41 has a central opening 41a. The opening 41a runs through the thickness of the substrate portion 41. The opening 41a is provided to receive the protrusion 22 of the operating member 2. On the back surface of the substrate portion 41, the first connection portion 42, the second connection portion 43, and the flexible portion 44 are arranged in this order from the outer peripheral edge of the opening 41a. The first connection portion 42 is a part to come into contact with a reference electrode 713 (to be described later) of the sensor board 7. The second connection portion 43 is a part to come into contact with a switch electrode 714 (to be described later) of the sensor board 7. The flexible portion 44 is a part that supports the moving electrode 4 and is to be fixed onto the sensor board 7. The flexible portion 44 supports the operating member 2 by supporting the moving electrode 4. The rear end surface of the flexible portion 44 is fixed onto the sensor board 7 (more specifically, to the first board 711 of a sensor unit 71 (to be described later)). The area, located between the first connection portion 42 and the second connection portion 43, of the back surface of the substrate portion 41 is an area that faces a fixed electrode 712 (to be described later) of the sensor board 7 and that constitutes the smooth planar portion 45.

(Adhesive sheet and insulating film) The front adhesive sheet 3 is a double-sided adhesive sheet for use to fix the moving electrode 4 to the operating member 2. The front adhesive sheet 3 may have, for example, an annular sheet shape. The front adhesive sheet 3 is interposed between the front surface of the substrate portion 41 of the moving electrode 4 and the back surface of the substrate portion 21 of the operating member 2. This allows the front surface of the moving electrode 4 (i.e., the front surface of the substrate portion 41) to be fixed onto the back surface of the operating member 2 (i.e., the back surface of the substrate portion 21) with the front adhesive sheet 3.

The rear adhesive sheet 5 is a double-sided adhesive sheet for use to fix the rear end surface of the flexible portion 44 of the moving electrode 4 to the sensor board 7. The rear adhesive sheet 5 may have, for example, an annular sheet shape. The rear adhesive sheet 5 is interposed between the rear end surface of the flexible portion 44 and the front surface of the sensor board 7. The rear adhesive sheet 5 allows the rear end surface 44a of the flexible portion 44 to be fixed onto the front surface of the sensor board 7.

The insulating film 6 is an insulating member provided to prevent the fixed electrode 712 (to be described later) of the sensor board 7 and the moving electrode 4 from being short-circuited with each other. The insulating film 6 may have, for example, an annular sheet shape. The insulating film 6 is affixed onto the fixed electrode 712 (to be described later) of the sensor board 7.

### (Sensor Board)

The sensor board 7 may be, for example, a flexible printed circuit (FPC) board. The sensor board 7 includes a sensor unit 71, a control unit 72, and a coupling portion 73 (refer to FIG. 4). The sensor unit 71 and the control unit 72 are coupled to each other via the coupling portion 73. The sensor board 7 is folded at the coupling portion 73 such that the sensor unit 71 is laid on top of (and forward of) the control unit 72. The sensor unit 71 is disposed on the front surface of the holder 8. The control unit 72 is disposed on the back surface of the holder 8.

The sensor unit 71 includes the first board 711 (board), the fixed electrode 712, the reference electrode 713, and the switch electrode 714. The first board 711 is a polygonal board, of which the shape is similar to the external shape of the operating member 2, for example. The first board 711 has an opening 711a to receive the protrusion 22 of the operating member 2. On the front surface of the first board 711, arranged are the fixed electrode 712, the reference electrode 713, and the switch electrode 714.

The control unit 72 includes a second board 721, a plurality of (e.g., three) light-emitting elements 722, and a control circuit 723 (refer to FIG. 5). The second board 721 is a polygonal board, of which the shape is similar to the external shape of the operating member 2, for example. The front surface of the second board 721 is provided with the three light-emitting elements 722. The three light-emitting elements 722 are arranged to respectively face the three incident portions (namely, one incident portion 22c and two incident portions 24c) of the operating member 2. On the back surface of the second board 721, the control circuit 723 (such as a control IC) is mounted.

The control circuit 723 detects, based on the capacitance of the fixed electrode 712, the tilt direction of the operating member 2 and the type of operation performed on the operating member 2 and outputs the results of detection to an external device. The control circuit 723 detects the tilt direction θ of the operating member 2 based on the capacitance values (C(Y+), C(Y−), C(X+), C(X−)) of the divided electrodes 10 in four directions (X+, X−, Y+, Y−) by the following

$$\begin{matrix}Equation ( 1 ) & \\ θ = arctan ( ( C ( Y + ) - C ( Y - ) ) / ( C ( X + ) - C ( X - ) ) ) & ( 1 )\end{matrix}$$

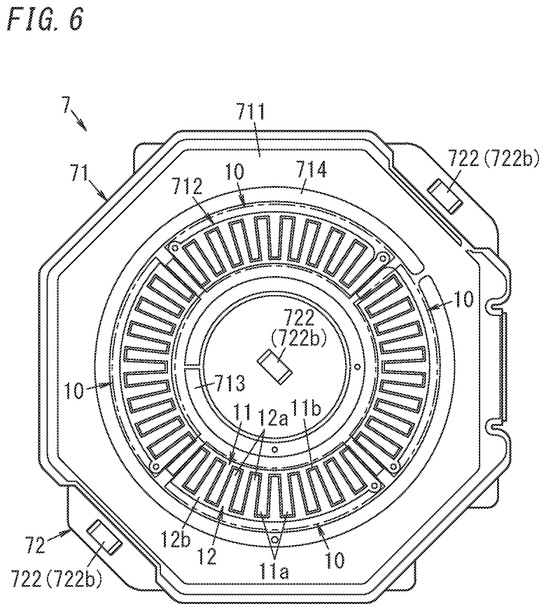

Note that in Equation (1), in a plane as viewed perpendicularly to the first board 711 of the sensor unit 71 (i.e., as viewed along a normal to the surface (mount surface) of the first board 711), XY coordinates are assigned with the center of the fixed electrode 712 defined to be the origin of the XY coordinate system. In this case, the four divided electrodes 10 are arranged on the positive side of the X-axis, the negative side of the X-axis, the positive side of the Y-axis, and the negative side of the Y-axis, respectively (refer to FIG. 6). These four divided electrodes 10 are the divided electrodes 10 in the four directions (X+, X−, Y+, Y−). Also, in Equation (1), θ is a direction angle defined around the origin of the XY coordinate system. As used herein, the “direction angle” refers to an angle representing any of the directions pointing radially from the origin of the XY coordinate system and indicating the direction in which the operating member 2 is tilted (i.e., tilt direction). In other words, the tilt direction θ is defined as a direction angle around the origin of the XY coordinate system. That is to say, this input device 1 defines the tilt direction to be a direction indicated by the direction angle determined by the tilt caused to the operating member 2 when the operating member 2 is pressed with the operating force applied thereto and tilted toward the direction in which the pressing force is applied.

In addition, the control circuit 723 also detects the potential (voltage) of the switch electrode 714 and outputs the result of detection to an external device. The control circuit 723 further controls lighting and extinction of the light-emitting elements 722 under the control of an external device.

### (Holder)

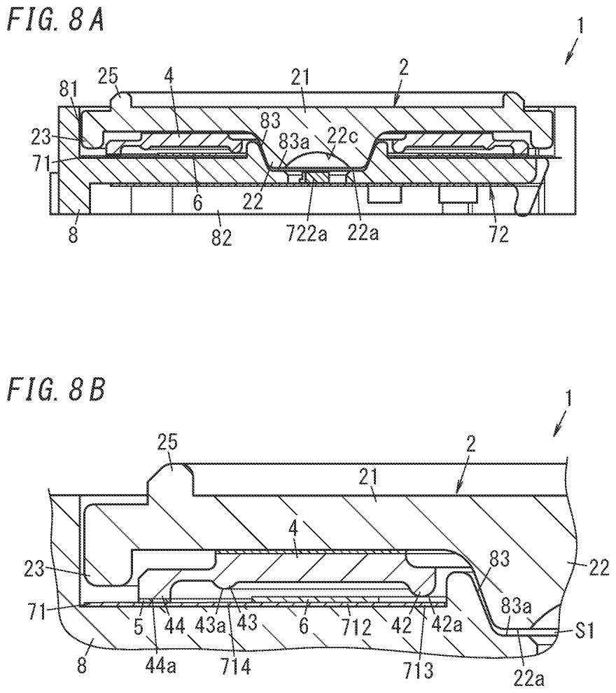

The holder 8 is a housing for housing internal components of the input device 1 (namely, the operating member 2, the front adhesive sheet 3, the moving electrode 4, the rear adhesive sheet 5, the insulating film 6, and the sensor board 7). The holder 8 may have, for example, a rectangular flat plate shape. The front side of the holder 8 has a first housing recess 81. In the first housing recess 81, housed are the operating member 2, the moving electrode 4, the insulating film 6, and the sensor unit 71 of the sensor board 7 (refer to FIG. 8A). The rear side of the holder 8 has a second housing recess 82. In the second housing recess 82, housed is the control unit 72 of the sensor board 7 (refer to FIG. 8A). The bottom surface of the first housing recess 81 has a recess 83 into which the protrusion 22 of the operating member 2 is fitted. The bottom surface 83a of the recess 83 is a flat surface, which is parallel to the bottom surface of the first housing recess 81. In addition, the bottom surface 83a of the recess 83 also has a through hole 84, through which the light emitted from the central light-emitting element 722a of the second board 721 of the control unit 72 is transmitted.

### (1-3) Details of Sensor Board

FIG. 6 is a plan view of the sensor board 7 as viewed in front of the sensor board 7. As shown in FIG. 6, the sensor board 7 includes the sensor unit 71 and the control unit 72. The sensor unit 71 is laid on top of (and forward of) the control unit 72.

A central portion of the first board 711 of the sensor unit 71 has the opening 711a. On the front surface of the first board 711 of the sensor unit 71, the fixed electrode 712, the reference electrode 713, and the switch electrode 714 are arranged to surround the outer periphery of the opening 711a.

The fixed electrode 712 is disposed on the front surface of the first board 711 as a ringlike (e.g., annular) electrode surrounding the outer periphery of the opening 711a. The fixed electrode 712 includes a plurality of (e.g., four) divided electrodes 10 which are arranged in a ring (e.g., in a circle). Each divided electrode 10 has the shape of an arc formed by evenly dividing the fixed electrode 712 circumferentially into four parts in a step of 90 degrees. More specifically, each divided electrode 10 includes a drive electrode 11 and a reception electrode 12. The drive electrode 11 forms the inner peripheral part of the fixed electrode 712. The reception electrodes 12 form the outer peripheral part of the fixed electrode 712.

The drive electrode 11 is a ringlike (e.g., annular) electrode to be used in common between the plurality of divided electrodes 10. The drive electrode 11 includes a plurality of first comb-tooth electrodes 11a and a first coupling portion 11b. The first coupling portion 11b has a ringlike (e.g., annular) band shape. The plurality of first comb-tooth electrodes 11a are arranged at regular intervals along the circumference of the first coupling portion 11b and protrudes toward the outer periphery of the fixed electrode 712.

Each of the reception electrodes 12 is an arc-shaped electrode provided on an individual basis for an associated divided electrode 10. Each reception electrode 12 includes a plurality of second comb-tooth electrodes 12a and a second coupling portion 12b. The second coupling portion 12b has an arc shape. The plurality of second comb-tooth electrodes 12a are arranged at regular intervals along the arc of the second coupling portion 12b and protrudes toward the inner periphery of the fixed electrode 712. The plurality of second comb-tooth electrodes 12a meshes with the plurality of first comb-tooth electrodes 11a. The respective reception electrodes 12 are arranged along the circumference of the drive electrode 11 and on the outer periphery of the drive electrode 11.

The capacitance of each divided electrode 10 is the quantity of electrical charge per unit voltage, which is stored between the drive electrode 11 and its associated reception electrode 12. The capacitance of each divided electrode 10 varies on an individual basis according to the relative arrangement of the divided electrode 10 and the moving electrode 4. The tilt direction θ of the moving electrode 4 (i.e., the tilt direction of the operating member) may be detected by the Equation (1) based on the balance in capacitance between the respective divided electrodes 10.

The reference electrode 713 is disposed on the front surface of the first board 711 as a ringlike (e.g., annular) electrode inside the fixed electrode 712. The switch electrode 714 is disposed on the front surface of the first board 711 as a ringlike (e.g., annular) electrode outside the fixed electrode 712. The reference electrode 713 and the switch electrode 714 are arranged concentrically with the fixed electrode 712. Each of the reference electrode 713 and the switch electrode 714 is a ringlike (e.g., annular) electrode.

When viewed in plan perpendicularly to the first board 711, the fixed electrode 712, the reference electrode 713, and the switch electrode 714 are arranged concentrically with each other with respect to the center of the pressure receiving surface 21a of the operating member 2.

The light-emitting element 722a (722) is disposed in the central area of the front surface of the second board 721 of the control unit 72. The light-emitting elements 722b are arranged at the two corner portions of the front surface of the second board 721. The two corner portions are arranged along a diagonal that passes through the center of the second board 721 on the front surface of the second board 721. The central light-emitting element 722a is exposed forward through the opening 711a of the first board 711 of the sensor unit 71 to make the light (lighting light) incident on the incident portion 22c of the operating member 2 disposed forward of the light-emitting element 722a. The light-emitting elements 722b on the two corner portions are arranged outside of the first board 711 of the sensor unit 71 and exposed on the front side of the first board 711 of the sensor unit 71 to make the light (lighting light) incident on the incident portions 24c of the operating member 2 disposed forward of the respective light-emitting elements 722b.

### (1-4) Details of Operating Member and Moving Electrode

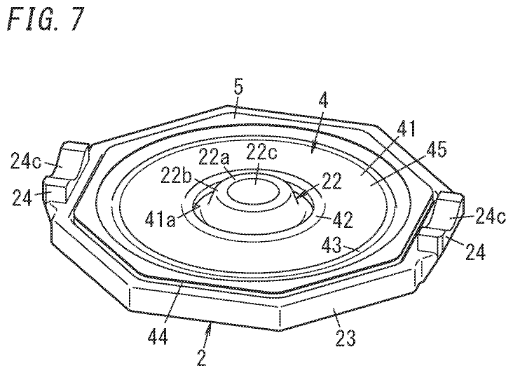

FIG. 7 is a perspective view as viewed from the backside (rear side) to illustrate how the operating member 2 and the moving electrode 4 are assembled together.

The back surface of the operating member 2 (i.e., the back surface of the substrate portion 21) includes the protrusion 22 and the back surface rib 23. The protrusions 24 are provided on the outer peripheral surface of the back surface rib 23.

The moving electrode 4 is affixed, with the front adhesive sheet, to the planar portion, located between the protrusion 22 and the back surface rib 23, of the back surface of the operating member 2. The back surface of the moving electrode 4 (i.e., the back surface of the substrate portion 41) has the opening 41a in the central portion thereof. The opening 41a receives the protrusion 22 of the operating member 2.

The back surface of the moving electrode 4 has the first connection portion 42, the second connection portion 43, the flexible portion 44, and the planar portion 45.

The planar portion 45 is an area that faces the fixed electrode 712 of the sensor board 7. The planar portion 45 is an annular and smooth flat surface surrounding the outer periphery of the opening 41a which forms part of the back surface of the moving electrode 4. The first connection portion 42 is a part to come into contact with the reference electrode 713 of the sensor board 7 and provided an annular portion along the inner circumferential edge of the planar portion 45. The first connection portion 42 protrudes backward of the substrate portion 41 (i.e., toward the first board 711 of the sensor board 7). The second connection portion 43 is a part to come into contact with the switch electrode 714 of the sensor board 7 and is provided as an annular portion along the outer circumferential edge of the planar portion 45. The second connection portion 43 protrudes backward of the substrate portion 41. The rear end surface 42a of the first connection portion 42 protrudes further backward than the rear end surface 43a of the second connection portion 43 does (refer to FIG. 8B). The flexible portion 44 is a part to support the moving electrode 4 and to be fixed onto the sensor board 7. The flexible portion 44 is provided in the shape a polygonal (e.g., regular octagonal) ring along the outer peripheral edge of the substrate portion 41 and protrudes backward of the substrate portion 41. The rear adhesive sheet 5 is adhered to the rear end surface of the flexible portion 44 to fix the moving electrode 4 to the sensor board 7. The first connection portion 42, the second connection portion 43, and the flexible portion 44 are all flexible.

When viewed in plan perpendicularly to the pressure receiving surface 21a of the operating member 2 (i.e., when viewed in plan perpendicularly to the first board 711 of the sensor board 7), the first connection portion 42 and the second connection portion 43 are concentric with each other with respect to the center of the pressure receiving surface 21a of the operating member 2.

The top surface (i.e., the contact surface 22a) of the protrusion 22 of the operating member 2, the top surface of the back surface rib 23, the planar portion 45 of the moving electrode 4 affixed to the operating member 2, the rear end surface 42a of the first connection portion 42, and the rear end surface 43a of the second connection portion 43 are parallel to each other.

The flexible portion 44 maintains the orientation of the operating member 2 to make the planar portion 45 parallel to the fixed electrode 712 of the sensor board 7 unless the operating member 2 is operated. In addition, the flexible portion 44 supports the operating member 2 to leave a gap S1 between the contact surface 22a of the protrusion 22 of the operating member 2 and the bottom surface 83a of the recess 83 of the holder 8 unless the operating member 2 is operated (refer to FIG. 8B). Furthermore, the flexible portion 44 applies biasing force to the operating member 2 to make the planar portion 45 parallel to the fixed electrode 712 again when the operating member 2 is operated.

### (1-5) Operation of Input Device

### (Standby State of Input Device)

FIGS. 8A and 8B are cross-sectional views illustrating a standby state of the input device 1. As used herein, the “standby state” of the input device 1 refers to a state where the operating member 2 of the input device 1 is not operated by the operator (i.e., a state where the operating button 520 of the assembled device 500 is not operated by the operator). As shown in FIGS. 8A and 8B, when the input device 1 is in the standby state, the flexible portion 44 of the moving electrode 4 maintains the orientation of the operating member 2 to make the planar portion 45 of the moving electrode 4 parallel to the fixed electrode 712 of the sensor board 7. In this state, the first connection portion 42 of the moving electrode 4 is out of contact with the reference electrode 713 and the second connection portion 43 of the moving electrode 4 is also out of contact with the switch electrode 714. The rear end surface 42a of the first connection portion 42 protrudes further backward than the rear end surface 43a of the second connection portion 43 does (i.e., protrudes toward the sensor board 7). In addition, the gap S1 is left between the contact surface 22a of the protrusion 22 of the operating member 2 and the bottom surface 83a of the recess 83 of the holder 8.

### (Centrally Pushed State)

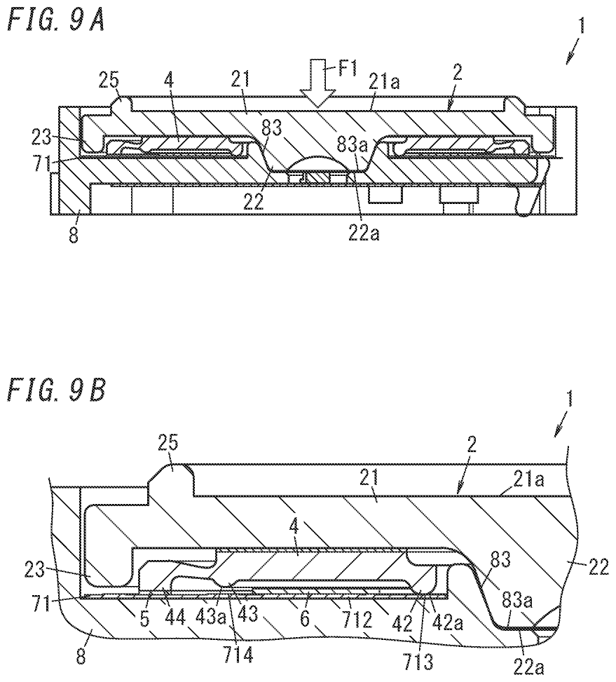

FIGS. 9A and 9B are cross-sectional views illustrating a centrally pushed state of the input device 1. As used herein, the “centrally pushed state” of the input device 1 refers to a state where application of operating force F1 to the central portion of the pressure receiving surface 21a of the operating member 2 of the input device 1 causes the operating member 2 to be displaced in the direction in which the operating force F1 is applied as shown in FIG. 9A. That is to say, the centrally pushed state of the input device 1 refers to a state where the operating member 2 is pressed down without tilting as a result of a press operation performed by the operator while the input device 1 is in the standby state (i.e., a state where the operating member 2 is pushed down perpendicularly to the first board 71 of the sensor board 7 (a state where the operating member 2 has moved vertically)).

More specifically, when the input device 1 is in the centrally pushed state, the press operation performed by the operator causes the operating member 2 to be pushed down into the holder 8 without causing the pressure receiving surface 21a of the operating member 2 to tilt with respect to the direction in which the operating force F1 is applied as shown in FIGS. 9A and 9B. In addition, this brings the contact surface 22a of the protrusion 22 of the operating member 2 into contact (e.g., a plane contact) with the bottom surface 83a of the recess 83 of the holder 8. In this state, the rear end surface 42a of the first connection portion 42 protrudes further backward than the rear end surface 43a of the second connection portion 43 does. Thus, although the first connection portion 42 of the moving electrode 4 comes into contact with the reference electrode 713 of the sensor board 7, the second connection portion 43 of the moving electrode 4 is still out of contact with the switch electrode 714 of the sensor board 7.

Bringing the first connection portion 42 into contact with the reference electrode 713 as described above changes the potential at the moving electrode 4 from a floating potential into a reference potential, thus causing the moving electrode 4 to attract electrical charges from the fixed electrode 712. As a result, the capacitance of the fixed electrode 712 changes. Then, the control circuit 723 detects this change. Based on the result of detection (i.e., respective capacitance values at the four divided electrodes 10 of the fixed electrode 712), the control circuit 723 may detect the operation performed on the operating member 2. For example, the control circuit 723 may detect, for example, application of the operating force F1 to the operating member 2, the tilt direction or tilt angle of the operating member 2, and the type of the operation performed.

### (Tilted State)

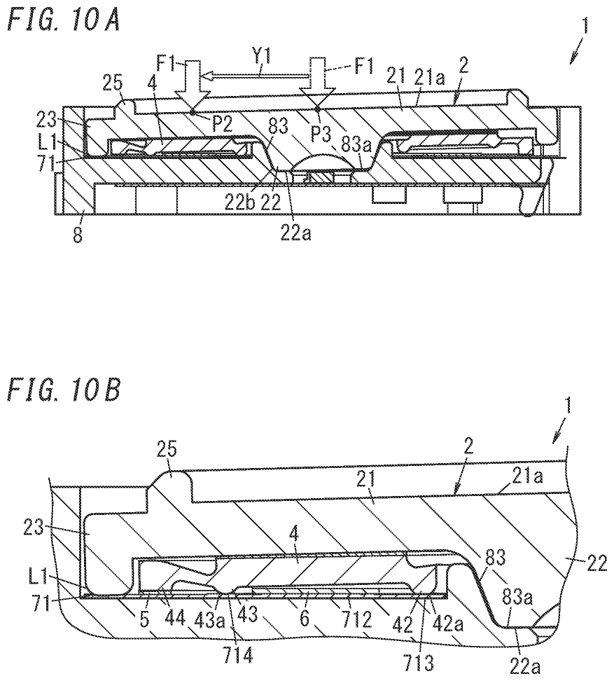

FIGS. 10A and 10B are cross-sectional views illustrating a tilted state of the input device 1. As used herein, the “tilted state” of the input device 1 refers to a state where application of the operating force F1 to a point on the outer peripheral edge of the pressure receiving surface 21a of the operating member 2 of the input device 1 causes the operating member 2 to be tilted with respect to the direction in which the operating force F1 is applied as shown in FIG. 10A. That is to say, the tilted state of the input device 1 herein refers to a state where the tilt operation performed by the operator causes the operating member 2 to be tilted. As used herein, the “tilt operation” refers to the operation of causing the operating member 2 to be tilted with respect to the direction in which the operating member 2 is pressed (i.e., the direction perpendicular to the first board 711 of the sensor board 7) by pressing down the operating member 2. In the example shown in FIG. 10A, the operating force F1 applied to the center P3 of the pressure receiving surface 21a of the operating member 2 in the centrally pushed state shown in FIG. 9A is transferred to a point P2 on the outer edge thereof as indicated by the arrow Y1.

As shown in FIG. 10B, in the tilted state of the input device 1, the tilt operation performed by the operator causes the operating member 2 to be tilted with respect to the direction in which the operating force F1 is applied to the point that one side L1 that forms part of the external shape of the operating member 2 (more specifically, one side that forms part of the external shape of the rear end surface of the back surface rib 23) comes into contact with the sensor unit 71 (board) of the sensor board 7. At this time, the operating member 2 tilts on a fulcrum of tilting defined by the protrusion 22 of the operating member 2. More specifically, the operating member 2 tilts on a fulcrum of tilting defined by a point on the contour 22b of the contact surface 22a of the protrusion 22.

Also, when the operating member 2 tilts, the moving electrode 4 also tilts integrally with the operating member 2. As a result, in one part, subjected to the press operation, of the moving electrode 4 (i.e., on the left side of FIG. 10A), the gap between the moving electrode 4 and the fixed electrode 712 of the sensor board 7 narrows as shown in FIGS. 10A and 10B. On the other hand, in the other part, opposite from that part subjected to the press operation, of the moving electrode 4 (i.e., on the right side of FIG. 10A), the gap between the moving electrode 4 and the fixed electrode 712 of the sensor board 7 widens. As a result, in that part, subjected to the press operation, of the moving electrode 4, while the first connection portion 42 of the moving electrode 4 keeps in contact with the reference electrode 713 of the sensor board 7, the second connection portion 43 thereof also comes into contact with the switch electrode 714 of the sensor board 7 (refer to FIG. 10B). Thus, the switch electrode 714 is connected to the reference electrode 713 via the moving electrode 4. This changes the potential at the switch electrode 714 into the same potential (i.e., reference potential) as the potential at the reference electrode 713. This change is detected by the control circuit 723. Consequently, the control circuit 723 detects that the operating member 2 has tilted to a predetermined tilt angle (i.e., a tilt angle at which the tilt direction of the operating member 2 may be detected with good stability).

As can be seen, in this input device 1, subjecting the operating member 2 to a press operation brings the first connection portion 42 into contact with the reference electrode 713 first to change the potential at the moving electrode 4 into a reference potential. As a result, the capacitance of the fixed electrode 712 (i.e., the capacitance between the drive electrode 11 and the reception electrode 12) changes to make the operation performed on the operating member 2 detectible. Furthermore, subjecting the operating member 2 to a tilt operation brings the second connection portion 43 into contact with the switch electrode 714, thus turning the potential at the switch electrode 714 into the reference potential via the moving electrode 4. Turning the potential at the switch electrode 714 into the reference potential in this manner enables detecting that the operating member 2 has tilted to a predetermined tilt angle (i.e., a tilt angle at which the tilt direction of the operating member 2 may be detected with good stability). Consequently, a determination may be made whether the operation has been detected in a range where the tilt angle of the operating member 2 is equal to or greater than a predetermined tilt angle. In addition, as described above, the operation may be detected in not only a range where the tilt angle of the operating member 2 is equal to or greater than the predetermined tilt angle but also a range where the tilt angle of the operating member 2 is less than the predetermined tilt angle. Consequently, the operation may be detected even when the tilt angle of the operating member 2 falls within a broader range.

In the example described above, performing the press operation on the central portion of the pressure receiving surface 21a of the operating member 2 and the operation of shifting the press point from the central portion of the pressure receiving surface 21a to a point on the outer edge thereof brings the first connection portion 42 into contact with the reference electrode 713 first, and then brings the second connection portion 43 into contact with the switch electrode 714. However, this is only an example and should not be construed as limiting. Alternatively, the first connection portion 42 may be brought into contact with the reference electrode 713 first, and then the second connection portion 43 may be brought into contact with the switch electrode 714 just by performing a press operation on a single point on the outer edge of the pressure receiving surface 21a of the operating member 2.

### (1-6) Detailed Tilt Direction of Operating Member Subjected to Tilt Operation

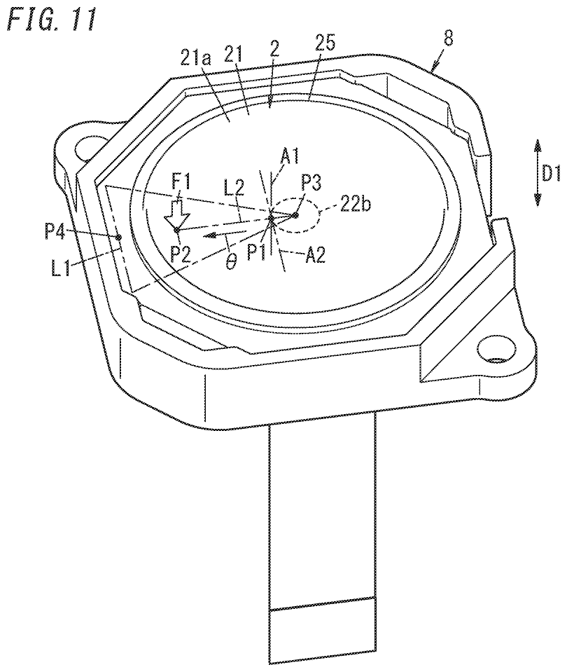

When the operating member 2 is subjected to a tilt operation as in the tilted state shown in FIGS. 10A and 10B, until the outer periphery of the operating member 2 comes into contact with the sensor unit 71 when viewed in plan in a direction D1 perpendicular to the first board 711 of the sensor board 7, the operating member 2 tilts on a predetermined tilt axis A1 as shown in FIG. 11. Suppose, in the plan view, an intersection between a virtual line L2 that connects a press point P2 on which the press operation is performed (i.e., the point of application to which the operating force F1 is applied) in the operating member 2 to the center P3 of the pressure receiving surface 21a of the operating member 2 and the contour 22b of the contact surface 22a is a first intersection P1. In that case, in the plan view, the predetermined tilt axis A1 is a tangential line drawn to pass through the first intersection P1 on the contour 22b of the contact surface 22a. Thus, the tilt direction θ of the operating member 2 before the outer periphery of the external shape of the operating member 2 comes into contact with the sensor unit 71 of the sensor board 7 is a direction pointing from the first intersection P1 toward the press point P2 in the plan view.

When the operating member 2 is further tilted to the point of bringing, in its entirety, one side (e.g., one side L1) of the external shape (e.g., regular octagonal shape) of the operating member 2 into contact with the front surface of the sensor unit 71, the operating member 2 tilts on another predetermined tilt axis A2 as shown in FIG. 11. The predetermined tilt axis A2 is a tangential line parallel to the one side L1 and drawn to pass through another intersection on the contour 22b of the contact surface 22a in the plan view. Specifically, supposing an intersection between a virtual line that connects the center P3 of the contact surface 22a to a midpoint P4 of the one side L1 and the contour 22b of the contact surface 22a is a second intersection, the predetermined tilt axis A2 is a tangential line drawn to pass through the second intersection on the contour 22b of the contact surface 22a in the plan view. Thus, the tilt direction θ of the operating member 2 when the one side L1 comes into contact in its entirety with the front surface of the sensor unit 71 of the sensor board 7 is a direction pointing from the center P3 of the contact surface 22a toward the midpoint P4 of the one side L1 in the plan view. If the external shape of the operating member 2 is a regular octagonal shape, the direction pointing from the center P3 of the contact surface 22a toward the midpoint P4 of the one side L1 is a perpendicular bisector with respect to the one side L1 in the plan view.

As can be seen, forming the operating member 2 in a polygonal (e.g., regular octagonal) external shape limits the tilt direction θ, in which the operating member 2 may be tilted when the one side of the external shape of the operating member 2 comes into contact with the front surface of the sensor unit 71, to a direction aligned with a perpendicular bisector with respect to each side of the polygon of the operating member 2. This makes the operator choose his or her desired tilt direction θ from a plurality of directions aligned with the perpendicular bisectors with respect to the respective sides of the polygonal operating member 2 (i.e., a number of directions limited to a certain degree), thus allowing him or her to have the operating member 2 tilted toward his or her desired tilt direction θ without hesitation.

(1-7) Relative Arrangement of Divided Electrodes with Respect to External Shape of Operating Member

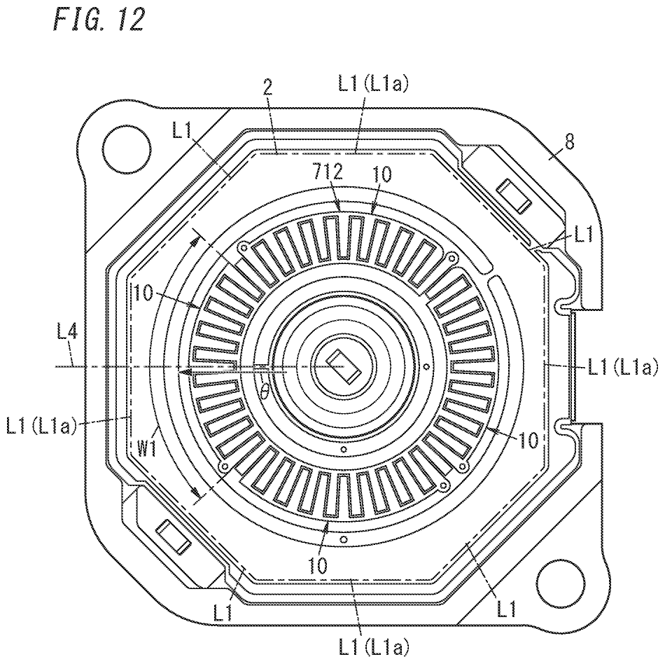

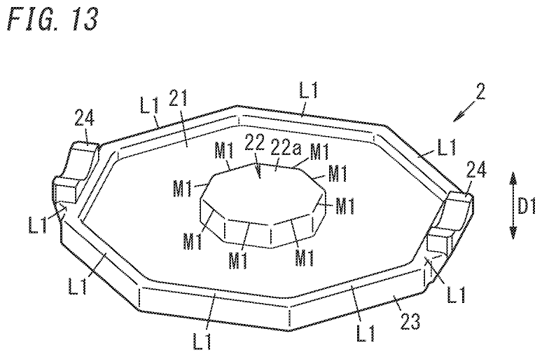

As shown in FIG. 12, in the input device 1, the operating member 2 has a polygonal (e.g., regular octagonal) external shape with a plurality of (e.g., eight) sides. The fixed electrode 712 includes a plurality of (e.g., four) divided electrodes 10 arranged in a ring (e.g., in a circle). When viewed in plan perpendicularly to the first board 711 of the sensor board 7, a bisector L4 that evenly divides, into two, the width W1 (of the arc) of each of the plurality of divided electrodes 10 also evenly divides, into two, one of the plurality of sides L1 that define the (polygonal) external shape of the operating member 2.

More specifically, in this embodiment, the number (e.g., four) of the divided electrodes 10 is a half as large as the number (e.g., eight) of the sides that define the (e.g., regular octagonal) external shape of the operating member 2. In addition, the respective widths W1 (of the arcs) of those divided electrodes 10 are equal to each other. The four divided electrodes 10 are each associated one to one with every other side L1a along the circumference of the operating member 2 (i.e., any of the four sides L1a out of the eight sides L1 of the operating member 2). In addition, the bisector L4 that evenly divides, into two, the width W1 of each divided electrode 10 also evenly divides an associated sides L1a into two. That is to say, in this embodiment, the relative arrangement of the respective divided electrodes 10 with respect to the operating member 2 is determined such that each of the bisectors L4 evenly divides an associated side L1 into two. In this case, each side L1a intersects at right angles with an associated bisector L4. In this case, the tilt direction θ of the operating member 2 when the tilt of the operating member 2 brings the associated one side L1a into contact, in its entirety, with the front surface of the sensor unit 71 of the sensor board 7 is aligned with the bisector L4.

According to this configuration, when subjecting the operating member 2 to a tilt operation causes the operating member 2 to be tilted, the respective capacitances of the plurality of divided electrodes 10 are distributed symmetrically with respect to the bisector L4 that is parallel to the tilt direction θ of the operating member 2. This allows the tilt direction θ of the operating member 2 to be detected with good stability.

### (1-8) Main Advantages

An input device according to this embodiment includes a board (first board 711), a fixed electrode 712, a reference electrode 713, a switch electrode 714, an operating member 2, and a moving electrode 4. The fixed electrode 712, the reference electrode 713, and the switch electrode 714 are provided for the board 711. The operating member 2 is arranged to face the board 711 and is vertically movable and tiltable with respect to the board 711 when subjected to a press operation. The moving electrode 4 is provided for the operating member 2 and is movable integrally with the operating member 2. The moving electrode 4 includes a first connection portion 42 and a second connection portion 43. The first connection portion 42 is arranged to face the reference electrode 713. The second connection portion 43 is arranged to face the switch electrode 714. Subjecting the operating member 2 to no press operation keeps the moving electrode 4 out of contact with the fixed electrode 712, the reference electrode 713, or the switch electrode 714. Subjecting the operating member 2 to a press operation brings the first connection portion 42 into contact with the reference electrode and then brings the second connection portion 43 into contact with the switch electrode 714.

According to this configuration, when the operating member 2 is subjected to a press operation, first, the first connection portion 42 comes into contact with the reference electrode 713 to change the potential at the moving electrode 4 into a reference potential. This causes the capacitance of the fixed electrode 712 to change, thus making the operation performed on the operating member 2 detectible. Thereafter, when the operating member 2 is further pressed down, the second connection portion 43 comes into contact with the switch electrode 714 to change the potential at the switch electrode 714 into the reference potential via the moving electrode 4. When the potential at the switch electrode 714 changes into the reference potential in this manner, detection is made that the operating member 2 has tilted to a predetermined tilt angle. This enables determining whether the operation has been detected in a range where the operating member 2 is tilted to an angle equal to or greater than a predetermined tilt angle. In addition, the operation may be detected in not only a range where the tilt angle of the operating member 2 is equal to or greater than the predetermined tilt angle as described above but also a range where the tilt angle of the operating member 2 is less than the predetermined tilt angle. Thus, the operation is detectible even when the tilt angle of the operating member 2 falls within a broader range. Consequently, the operation is detectible even when the tilt angle of the operating member 2 falls within a broader range. Besides, a determination may also be made whether the operation has been detected in a range where the tilt angle of the operating member 2 is equal to or greater than the predetermined tilt angle.

### (1-9) Variations

Next, variations of the first embodiment will be described. In the following description of the variations, any constituent element, having the same function as a counterpart of the first embodiment described above, will be designated by the same reference numeral as that counterpart's, and description thereof will be omitted herein. Thus, the following description will be focused on only the differences from the first embodiment. Optionally, the first embodiment and the variations to be described below may be adopted in combination as appropriate.

### (First Variation)

In the first embodiment described above, the contact surface 22a of the protrusion 22 of the operating member 2 has a circular external shape (refer to FIG. 5). On the other hand, in this variation, the contact surface 22a of the protrusion 22 of the operating member 2 has the same polygonal (e.g., regular octagonal) external shape as the operating member 2 (e.g., with a regular octagonal external shape). More specifically, the regular octagonal external shape formed by the contact surface 22a of the protrusion 22 of the operating member 2 is concentric with, and has the same orientation as, the regular octagonal external shape of the operating member 2. That is to say, each side M1 of the regular octagonal external shape formed by the contact surface 22a of the protrusion 22 of the operating member 2 is parallel to a corresponding side L1 of the regular octagonal external shape of the operating member 2.

In this variation, when the operating member 2 is subjected to a tilt operation, the operating member 2 tilts on one of the plurality of sides L1 defining the external shape of the contact surface 22a of the protrusion 22 as the tilt axis. According to this variation, the tilt direction θ of the operating member 2 may be limited from a range where the operating member 2 has a small tilt angle to a direction aligned with a perpendicular bisector with respect to each side M1 of the external shape formed by the contact surface 22a of the protrusion 22 of the operating member 2 when viewed in plan in a direction D1 perpendicular to the first board 711 of the sensor board 7.

According to this variation, a bisector L4 (refer to FIG. 12) that evenly divides, into two, the width W1 of each divided electrode 10 also evenly divides, into two, one of the plurality of sides M1 of the (polygonal) external shape formed by the contact surface 22a of the protrusion 22. In other words, the respective divided electrodes 10 and the protrusion 22 are arranged to meet this positional relationship. In that case, the tilt direction of the operating member 2 is aligned with the bisector that evenly divides, into two, one of the plurality of sides M1. According to this configuration, when subjecting the operating member 2 to a tilt operation causes the operating member 2 to be tilted, the respective capacitances of the plurality of divided electrodes 10 are distributed symmetrically with respect to the bisector that is aligned with the tilt direction of the operating member 2. This allows the tilt direction of the operating member 2 to be detected with good stability.

### (Second Variation)

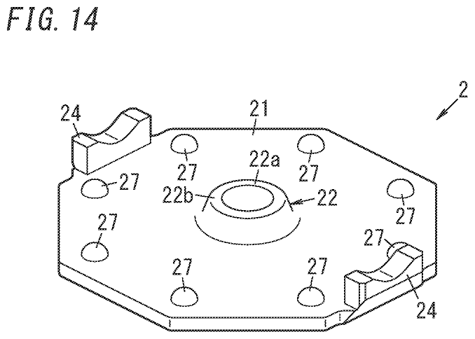

In the first embodiment described above, the operating member 2 includes the back surface rib 23 having a polygonal shape (e.g., a regular octagonal shape) in plan view. In this variation, the back surface rib 23 is replaced with a plurality of (e.g., eight) projections 27 arranged along the outer peripheral edge of the back surface of the substrate portion 21 of the operating member 2 (i.e., the surface that faces the holder 8) as shown in FIG. 14. The plurality of projections 27 are arranged at a plurality of points corresponding to (i.e., in the vicinity of) the respective vertices of the (regular octagonal) external shape of the operating member 2. Each of the plurality of projections 27 may have, for example, a hemispherical shape.

According to this variation, subjecting the operating member 2 to a tilt operation brings two adjacent projections 27 out of the plurality of projections 27 of the operating member 2 into contact with the front surface of the sensor unit 71 of the sensor board 7. In this case, the operating member 2 tilts on a virtual line that connects the two projections 27 together as a tilt axis. This variation also achieves the same advantages as the first embodiment.

According to this variation, a bisector L4 (refer to FIG. 12) that evenly divides, into two, the width W1 of each divided electrode 10 also evenly divides, into two, a line segment that connects together two adjacent projections 27 out of the plurality of projections 27. In other words, the respective divided electrodes 10 and the projection 27 are arranged to meet this positional relationship. In that case, the tilt direction of the operating member 2 is aligned with the bisector that evenly divides, into two, the line segment that connects together two adjacent projections 27 out of the plurality of projections 27. According to this configuration, when subjecting the operating member 2 to a tilt operation causes the operating member 2 to be tilted, the respective capacitances of the plurality of divided electrodes 10 are distributed symmetrically with respect to the bisector that is aligned with the tilt direction of the operating member 2. This allows the tilt direction of the operating member 2 to be detected with good stability.

### (Third Variation)

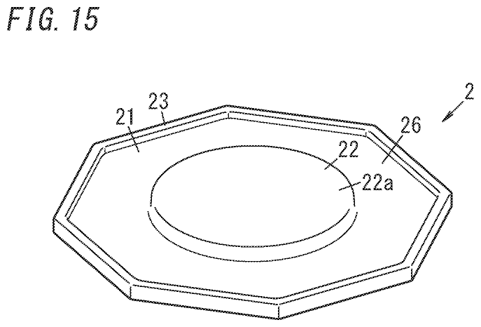

In the first embodiment described above, the contact surface 22a of the protrusion 22 of the operating member 2 is a flat surface. On the other hand, according to this variation, the contact surface 22a of the protrusion 22 of the operating member 2 is a convex curved surface (e.g., a gently curved hemispherical surface) as shown in FIG. 15. In this variation, the bottom surface 83a of the recess 83 of the holder 8 is a flat surface as in the first embodiment described above. In the example illustrated in FIG. 15, the diameter of the contact surface 22a of the protrusion 22 is larger than the diameter (refer to FIG. 5) of the protrusion 22 according to the first embodiment. However, the diameter of the contact surface 22a of the protrusion 22 is not limited to any particular value.

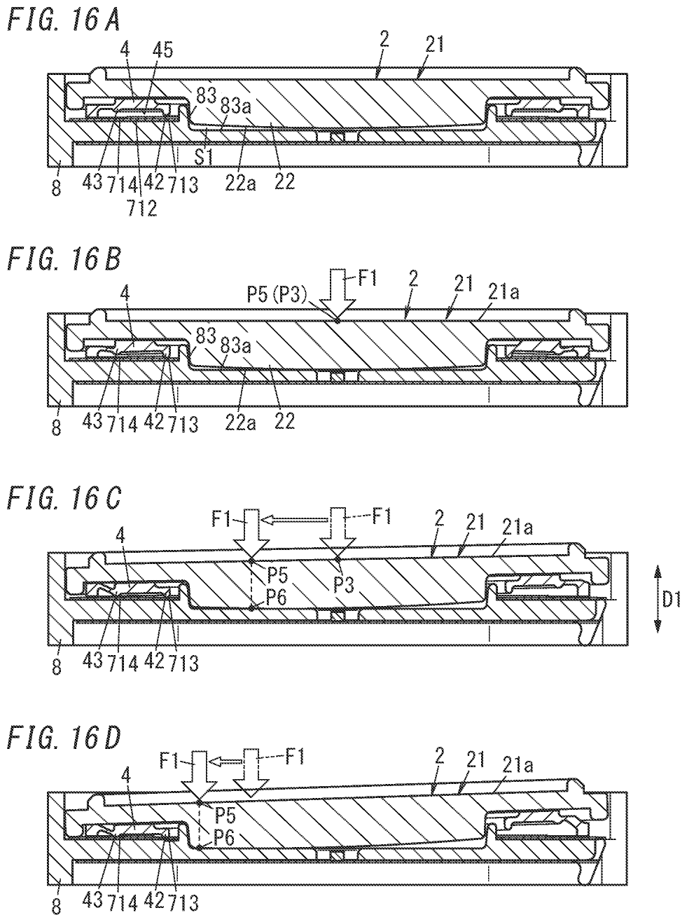

Next, an exemplary operation on the operating member 2 according to this variation (e.g., the operation of shifting the press point on the pressure receiving surface 21a of the operating member 2 from the center to a point on the outer edge) will be described with reference to FIGS. 16A-16D.

As shown in FIG. 16A, while the input device 1 is in the standby state, the first connection portion 42 of the moving electrode 4 is out of contact with the reference electrode 713 and the second connection portion 43 of the moving electrode 4 is out of contact with the switch electrode 714 as in the first embodiment described above. In addition, the planar portion 45 of the moving electrode 4 is parallel to the fixed electrode 712 of the sensor board 7. Furthermore, the gap S1 is left between the contact surface 22a of the protrusion 22 of the operating member 2 and the bottom surface 83a of the recess 83 of the holder 8.

As shown in FIG. 16B, when the input device 1 is in the centrally pushed state, the operating force F1 is also applied to the central portion of the pressure receiving surface 21a of the operating member 2 of the input device 1 as in the first embodiment described above. This causes the operating member 2 to be displaced in the direction in which the operating force F1 is applied, thus bringing the contact surface 22a of the protrusion 22 of the operating member 2 into contact with the bottom surface 83a of the recess 83 of the holder 8. In this variation, however, the contact surface 22a of the protrusion 22 has a convex curved shape, and therefore, only a central portion of the contact surface 22a of the protrusion 22 comes into contact with the bottom surface 83a of the recess 83 in the centrally pushed state. In this centrally pushed state, as well as in the centrally pushed state according to the first embodiment (refer to FIG. 9), the first connection portion 42 comes into contact with the reference electrode 713 but the second connection portion 43 is still out of contact with the switch electrode 714.

As shown in FIG. 16C, when the input device 1 is in a first tilted state, the press point P5 where the operating force F1 is applied has shifted from the center P3 of the pressure receiving surface 21a of the operating member 2 toward the outer edge thereof, thus causing the operating member 2 to be tilted. At this time, the contact surface 22a of the protrusion 22 of the operating member 2 comes into contact with the bottom surface 83a of the recess 83 of the holder 8 at one contact point P6. The operating member 2 tilts on this contact point P6 as the fulcrum of tilting (hereinafter referred to as a “fulcrum of tilting P6”). More specifically, supposing a virtual line that connects the center P3 of the pressure receiving surface 21a of the operating member 2 to the contact point P6 is drawn when the input device 1 is viewed in plan in a direction D1 perpendicular to the first board 711 of the sensor board 7, the operating member 2 tilts on a line, intersecting at right angles with the virtual line at the contact point P6, as the tilt axis in the plan view. The contact point P6 may be located, for example, to overlap with the press point P5 in the plan view.

Note that in this first tilted state, as in the first embodiment, the first connection portion 42 comes into contact with the reference electrode 713 and the second connection portion 43 comes into contact with the switch electrode 714 on a side to which the press point P5 on the operating member 2 has shifted.

As shown in FIG. 16D, in a second tilted state of the input device 1, the press point P5 to which the operating force F1 has been applied when the input device 1 is in the first tilted state has further shifted toward the outer edge, thus causing the operating member 2 to be further tilted. At this time, the contact surface 22a of the protrusion 22 of the operating member 2 also makes contact at one contact point P6 with the bottom surface 83a of the recess 83 of the holder 8.

As can be seen, according to this variation, as the press point P5 shifts on the pressure receiving surface 21a, the fulcrum of tilting P6 also shifts on the contact surface (convex curved surface) 22a accordingly. In this case, the fulcrum of tilting P6 shifts in the same direction as the press point P5. In the cases of the operations shown in FIGS. 16A-16D, the press point P5 shifts (slides), for example, along the diameter (i.e., the X-axis) of the pressure receiving surface 21a. In this case, the interval between the fixed electrode 712 and the moving electrode 4 changes continuously both on the positive X side and the negative X side. The shift of the press point P5 may be detected continuously by calculating the difference between the variation in the capacitance of the fixed electrode 712 on the positive X side and the variation in the capacitance of the fixed electrode 712 on the negative X side.

According to this variation, the contact surface 22a of the protrusion 22 (abutment portion) is a convex curved surface. Thus, as the press point P5 shifts, the fulcrum of tilting P6 also shifts and the operating member 2 smoothly changes its tilt accordingly. As a result, as the press point P5 shifts, the capacitance of the fixed electrode 712 changes smoothly. This allows, when performing the operation of linearly shifting the press point on the pressure receiving surface 21a of the operating member 2 (e.g., when performing a slide operation), the shift of the press point to be detected continuously.

### (Fourth Variation)

In the following description of a fourth variation, exemplary types of operating commands that may be entered into the assembled device 500 (input device 1) will be described.

The assembled device 500 (input device 1) according to this variation allows an operating command to be entered by at least one type of operation selected from the group consisting of a flick operation, a rotary operation, a swipe operation, and a slide operation.

### (Flick Operation)

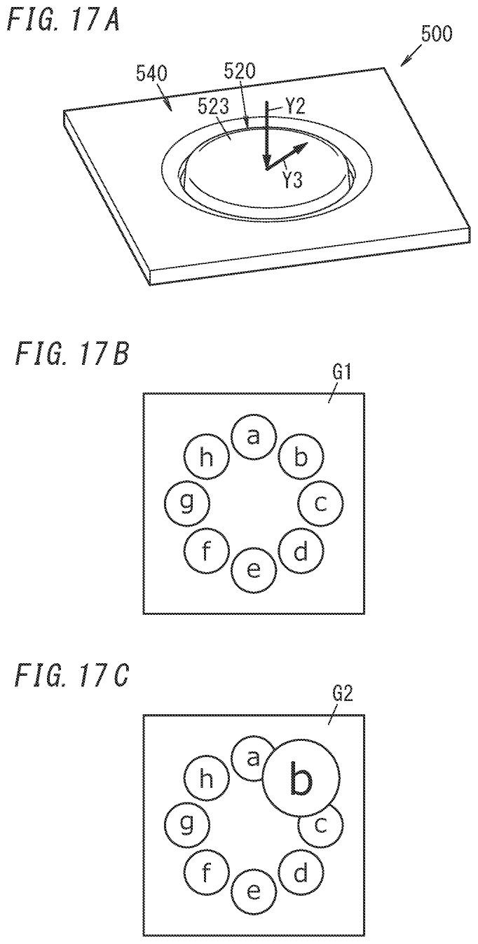

As indicated by the arrows Y2 and Y3 in FIG. 17A, the flick operation is the operation of pressing an operating surface 523 of the operating button 520 in a central portion thereof to cause a press point to shift from the central portion toward a certain point on the outer edge. In other words, the flick operation is the operation of pressing the pressure receiving surface 21a of the operating member 2 in a central portion thereof to cause a press point to shift from the central portion toward a certain point on the outer edge.

When the flick operation is performed, the operating surface 523 of the operating button 520 is touched (i.e., lightly pressed) in a central portion thereof, thus bringing the first connection portion 42 of the moving electrode 4 into contact with the reference electrode 713 of the sensor board 7. This turns the potential at the moving electrode 4 from a floating potential into a reference potential, thus causing the moving electrode 4 to attract electrical charges from the fixed electrode 712. As a result, the capacitance of the fixed electrode 712 changes. The control circuit 723 detects, based on this change in the capacitance, that the operating member 2 has been subjected to the press operation and outputs the result of detection to an external device (such as a display device).

If the control circuit 723 outputs this result of detection to a display device, for example, the display device displays a predictive text input screen G1 (refer to FIG. 17B). The predictive text input screen G1 may be, for example, a screen on which icons “a” to “h” are arranged in a circular pattern. The operator moves (i.e., slides), on the operating surface 523 of the operating button 520, one of his or her fingers toward a direction where any desired icon (such as the icon “b”) is located. This finger movement causes the operating button 520 and the operating member 2 to be tilted integrally with each other, thus bringing the first connection portion 42 of the moving electrode 4 into contact with the reference electrode 713 of the sensor board 7 and then bringing the second connection portion 43 of the moving electrode 4 into contact with the switch electrode 714 of the sensor board 7. This brings the switch electrode 714 into electrical contact with the reference electrode 713 via the moving electrode 4. As a result, the potential at the switch electrode 714 changes into the reference potential. The control circuit 723 detects, by sensing this change, that the operating member 2 has been tilted to a predetermined tilt angle (i.e., a tilt angle at which the tilt direction of the operating member 2 may be detected with good stability).

The control circuit 723 detects the capacitance values (C(Y+), C(Y−), C(X+), C(X−)) of the divided electrodes 10 in the four directions (X+, X−, Y+, Y−) and determines, based on the balance, the tilt direction θ of the operating member 2 (θ=arctan ((C(Y+)−C(Y−))/(C(X+)−C(X−))). For example, the control circuit 723 detects that the tilt direction θ of the operating member 2 is a direction in which the icon “b” is selected on the predictive text input screen G1. Then, the control circuit 723 makes the external display device show the result of the tilt direction θ thus determined on the predictive text input screen G2 (such as the predictive text input screen G2 shown in FIG. 17C). In the example shown in FIG. 17C, the external display device displays the icon “b” on a larger scale on the predictive text input screen G2, thereby showing the result of detection (i.e., the tilt direction θ thus determined) provided by the control circuit 723.

As can be seen, the flick operation may be used when the operator operates the operating button 520 to select any desired icon, while watching the display screen (predictive text input screen) of the display device, and has the result of selection shown on the display screen of the display device.

### (Rotary Operation)

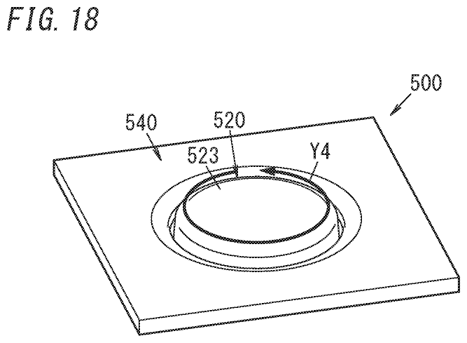

The rotary operation is the operation of pressing the operating surface 523 of the operating button 520 at an arbitrary point on the outer edge thereof to cause the press point to shift from the arbitrary point circularly along the outer edge as indicated by the arrow Y4 in FIG. 18. In other words, the rotary operation is the operation of pressing the pressure receiving surface 21a of the operating member 2 at an arbitrary point on the outer edge thereof to cause the press point to shift from the arbitrary point circularly along the outer edge.

When the rotary operation is performed, the operating surface 523 of the operating button 520 is touched (i.e., lightly pressed) on the outer edge thereof, thus bringing the first connection portion 42 of the moving electrode 4 into contact with the reference electrode 713 of the sensor board 7. This turns the potential at the moving electrode 4 from a floating potential into the reference potential, thus causing the moving electrode 4 to attract electrical charges from the fixed electrode 712. As a result, the capacitance of the fixed electrode 712 changes. This change is detected by the control circuit 723. The control circuit 723 detects, based on this result of detection, that the operating member 2 has been subjected to the press operation.

Then, the operating button 520 (operating member 2) is tilted to bring the second connection portion 43 of the moving electrode 4 into contact with the switch electrode 714 of the sensor board 7. This brings the switch electrode 714 into electrical contact with the reference electrode 713 via the moving electrode 4. As a result, the potential at the switch electrode 714 changes into the reference potential. The control circuit 723 detects, by sensing this change, that the operating member 2 has been tilted to a predetermined tilt angle (i.e., a tilt angle at which the tilt direction of the operating member 2 may be detected with good stability). Thereafter, the control circuit 723 detects the capacitance values (C(Y+), C(Y−), C(X+), C(X−)) of the divided electrodes 10 in the four directions (X+, X−, Y+, Y−) and determines, based on the balance between the capacitance values thus detected, the tilt direction θ of the operating member 2 (θ=arctan ((C(Y+)−C(Y−))/((C(X+)−C(X−))). Then, the control circuit 723 outputs the tilt direction θ thus determined to the external device.

In this variation, the operating member 2 has a polygonal (e.g., regular octagonal) external shape. Therefore, when the operating surface 523 of the operating button 520 is subjected to the rotary operation, the tilt direction θ of the operating button 520 and the operating member 2 is limited to eight directions. That is why when used as an increment encoder, the operating button 520 may be used with eight pulses applied per rotation. Such a rotary operation may be used, for example, to scroll a list displayed on a display device and to control a sound volume.

### (Swipe Operation)

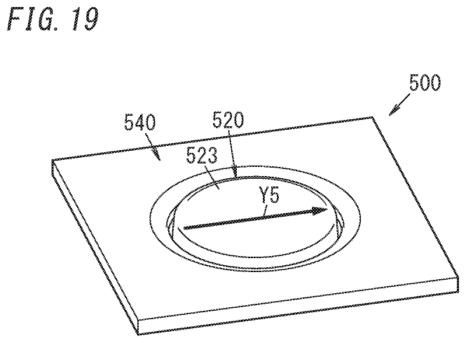

The swipe operation is the operation of pressing the operating surface 523 of the operating button 520 at an arbitrary point on the outer edge thereof to cause the press point to shift linearly to a point, opposite from the arbitrary point, on the outer edge through the center of the operating surface 523 as indicated by the arrow Y5 in FIG. 19. In other words, the swipe operation is the operation of pressing the pressure receiving surface 21a of the operating member 2 at an arbitrary point on the outer edge thereof to cause the press point to shift linearly to a point, opposite from the arbitrary point, on the outer edge through the center of the operating surface 523.

When the swipe operation is performed, the operating surface 523 of the operating button 520 is touched (i.e., lightly pressed) on the outer edge thereof, thus bringing the first connection portion 42 of the moving electrode 4 into contact with the reference electrode 713 of the sensor board 7. This turns the potential at the moving electrode 4 from a floating potential into the reference potential, thus causing the moving electrode 4 to attract electrical charges from the fixed electrode 712. As a result, the capacitance of the fixed electrode 712 changes. This change is detected by the control circuit 723. The control circuit 723 detects, based on this result of detection, that the operating member 2 has been subjected to the press operation.

Then, the operating member 2 is tilted to bring the second connection portion 43 of the moving electrode 4 into contact with the switch electrode 714 of the sensor board 7. This brings the switch electrode 714 into electrical contact with the reference electrode 713 via the moving electrode 4. As a result, the potential at the switch electrode 714 changes into the reference potential. The control circuit 723 detects, by sensing this change, that the operating member 2 has been tilted to a predetermined tilt angle (i.e., a tilt angle at which the tilt direction of the operating member 2 may be detected with good stability). Thereafter, the control circuit 723 detects the capacitance values (C(Y+), C(Y−), C(X+), C(X−)) of the divided electrodes 10 in the four directions (X+, X−, Y+, Y−) and determines, based on the balance between the capacitance values thus detected, the tilt direction θ of the operating member 2 (0=arctan ((C(Y+)−C(Y−))/(C(X+)−C(X−))). Then, the control circuit 723 outputs the tilt direction θ thus determined to the external device.

When performing this swipe operation, the operator moves, on the operating surface 523 of the operating button 520, one of his or her fingers linearly from the press point on the outer edge to the point, opposite from the arbitrary point, on the outer edge through the center of the operating surface 523. In this case, as the operator moves one of his or her fingers, the tilt of the operating button 520 decreases accordingly to bring the second connection portion 43 out of contact with the switch electrode 714. Nevertheless, the first connection portion 42 is still connected to the reference electrode 713. In addition, when the finger reaches the point on the opposite side of the operating surface 523, the operating member 2 tilts toward the opposite side to bring the second connection portion 43 into contact with the switch electrode 714 again. As a result, the tilt direction θ of the operating member 2 at the opposite press point is detected. While the finger is moving, the first connection portion 42 and the reference electrode 713 are always connected to each other. Thus, the control circuit 723 detects not only this movement of the finger as a series of operations but also this series of operations as a swipe operation along with the direction of movement. This swipe operation may be used, for example, to change on-screen images.

### (Slide Operation)

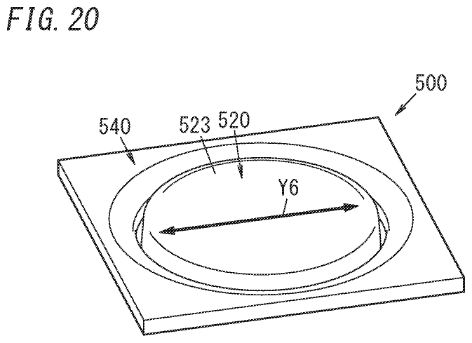

The slide operation is the operation of pressing the operating surface 523 of the operating button 520 at an arbitrary point to cause the press point to shift linearly as indicated by the arrow Y6 in FIG. 20. In other words, the slide operation is the operation of pressing the pressure receiving surface 21a of the operating member 2 at an arbitrary point to cause the press point to shift linearly.

When the slide operation is performed, the operating surface 523 of the operating button 520 is touched (i.e., lightly pressed), thus bringing the first connection portion 42 of the moving electrode 4 into contact with the reference electrode 713 of the sensor board 7. This turns the potential at the moving electrode 4 from a floating potential into the reference potential, thus causing the moving electrode 4 to attract electrical charges from the fixed electrode 712. As a result, the capacitance of the fixed electrode 712 varies. This change is detected by the control circuit 723. The control circuit 723 detects, based on this result of detection, that the operating member 2 has been subjected to the press operation.

If this slide operation is performed by the input device 1 according to the third variation, then the fulcrum of tilting P6 is a contact point between the contact surface (convex curved surface) 22a of the protrusion 22 of the operating member 2 and the bottom surface 83a of the recess 83 of the holder 8. Thus, as the press point P5 on the pressure receiving surface 21a of the operating member 2 is shifted, the fulcrum of tilting P6 also shifts accordingly. For example, as the press point P5 is shifted (slid) along the diameter (X-axis) of the pressure receiving surface 21a, the interval between the fixed electrode 712 and the moving electrode 4 changes continuously both on the positive X side and the negative X side. Then, the difference between the variation in the capacitance value of the fixed electrode 712 on the positive X side and the variation in the capacitance value of the fixed electrode 712 on the negative X side is calculated. This allows the shift of the press point P5 to be detected continuously. Such a slide operation may be used, for example, to zoom in or out an image displayed on the screen of a display device and to control a sound volume continuously.

### (Fifth Variation)

In the first embodiment described above, when the operating member 2 is operated, the protrusion 22 of the operating member 2 comes into contact with the holder 8 (more specifically, the bottom surface 83a of the recess 83). However, this is only an example and should not be construed as limiting. Alternatively, when the operating member 2 is operated, the protrusion 22 of the operating member 2 may come into contact with the first board 711 of the sensor board 7. In that case, the protrusion 22 is provided for a surface, facing the first board 711, of the operating member 2. That is to say, when the operating member 2 is operated, the protrusion 22 of the operating member 2 may come into contact with either the holder 8 or the first board 711, whichever is appropriate.

### (Other Variations)

In the first embodiment described above, the operating member 2 includes the protrusion 22 as the abutment portion and the holder 8 has the recess 83 into which the protrusion 22 is fitted. Alternatively, according to a first variation, the operating member 2 may have a recess 83 as the abutment portion and the holder 8 may have the protrusion 22.

Also, in the first embodiment described above, the top surface (contact surface) 22a of the operating member 2 is a flat surface. Alternatively, according to a second variation, the top surface 22a of the protrusion 22 may also be a curved surface with edge lines that form either a circle or a polygon in plan view. If the edge lines form a circle, then the operating member 2 tilts on a tangential line, drawn to pass through a point on the circle in plan view, as the tilt axis. On the other hand, if the edge lines form a polygon, then the operating member 2 tilts on one side of the polygon in plan view as the tilt axis.

Furthermore, according to a third variation of the first embodiment, the top surface 22a of the protrusion 22 of the operating member 2 (e.g., the outer edge of the top surface 22a) may further have a plurality of projections. The plurality of projections are arranged at (regular) intervals to form a (circular) ringlike pattern. The respective tip surfaces of the plurality of projections have the same height as measured from the top surface 22a of the protrusion 22. According to this variation, when the operating member 2 is tilted (i.e., subjected to atilt operation), the operating member 2 tilts on a line segment, which connects together the respective tips of two adjacent ones of the plurality of projections, as the tilt axis. Each of the plurality of projections may have a hemispherical shape. Alternatively, providing the plurality of projections for the top surface of the protrusion 22 may be replaced with increasing and decreasing, in a regular cycle, the height of the top surface 22a of the protrusion 22 (e.g., the outer edge of the top surface 22a) along the circumference thereof. In that case, a portion with the increased height serves as the projection.

Optionally, in the second and third variations described above, the operating member 2 may have the recess 83 and the holder 8 may have the protrusion 22 as in the first variation described above.

### (2) Second Embodiment

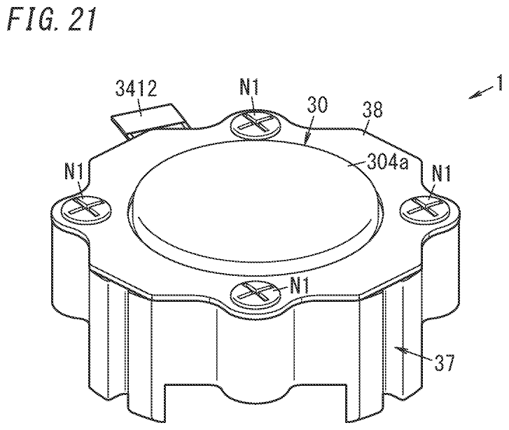

An input device 1 according to a second embodiment will be described with reference to FIGS. 21-28.

In the first embodiment described above, the operating member 30 is supported by the flexible portion 44 of the moving electrode 32. In this embodiment, the operating member 30 is supported by a spring 35, instead of the flexible portion 44. Also, although the reference electrode 713 is provided inside the fixed electrode 712, the reference electrode 713 is provided outside of the switch electrode 714 in this embodiment.

### (2-1) Configuration of Input Device

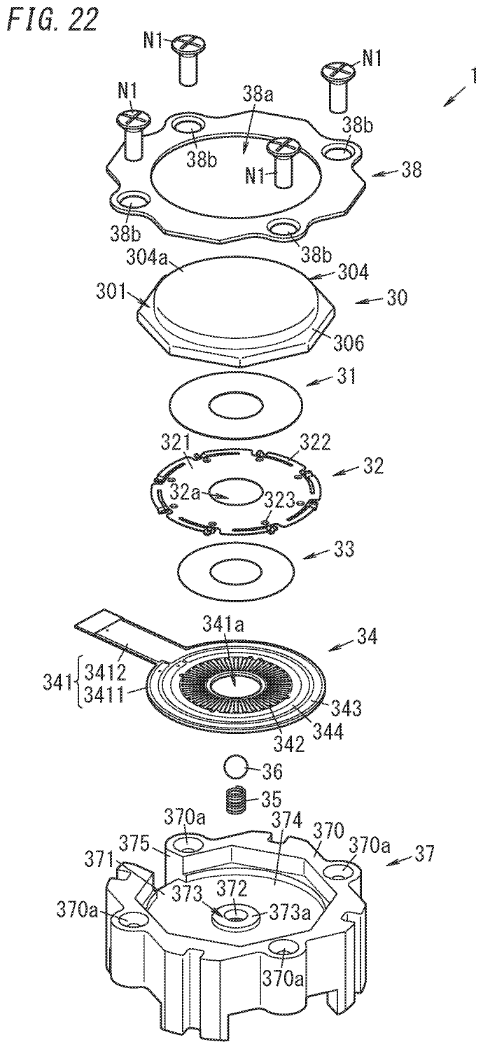

As shown in FIGS. 21 and 22, the input device 1 includes the operating member 30, an adhesive sheet 31, the moving electrode 32, an insulating film 33, a sensor board 34, the spring 35, a sphere 36, a first holder 37, and a second holder 38.

### (Operating Member)

The operating member 30 is a part through which an operator's operating command is entered. The operating member 30 may have, for example, the shape of a polygonal (e.g., regular octagonal) flat plate.

The operating member 30 includes a substrate portion 301, a recess 302, an abutment portion 303, an operating portion 304, a planar portion 305, and a flange portion 306.

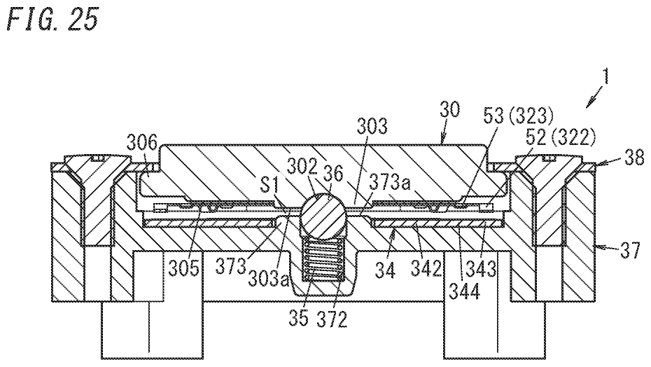

The substrate portion 301 may have the shape of a polygonal (e.g., regular octagonal) flat plate. A central portion of the back surface of the substrate portion 301 is provided with the recess 302 and the abutment portion 303, which are concentric with each other. On the back surface of the substrate portion 301, the area outside of the abutment portion 303 serves as the smooth planar portion 305 to which the moving electrode 32 is affixed (refer to FIG. 25). A central portion of the front surface of the substrate portion 301 is provided with the operating portion 304. The outer peripheral edge portion of the substrate portion 301 serves as the flange portion 306 protruding outward from the outer periphery of the operating portion 304.

The recess 302 is a part to receive the sphere 36. The inner surface of the recess 302 may be, for example, a hemispherical surface. The recess 302 is provided at the center of the back surface of the substrate portion 301.

The abutment portion 303 is apart to come into contact with a step portion 373 of the first holder 37. The abutment portion 303 is provided on the back surface of the substrate portion 301 to surround the recess 302 and may be, for example, an annular projection in plan view. The top surface (contact surface) 303a of the abutment portion 303 is a surface to come into contact with the top surface (contact surface) 373a of the step portion 373 of the first holder 37 and is parallel to the planar portion 305.

The operating portion 304 is a part that accepts the operator's operating command. The operating portion 304 is provided as a protrusion in the central portion of the front surface of the substrate portion 301 to have a circular shape in plan view. The operating portion 304 is concentric with respect to the center of the recess 302. The front surface of the operating portion 304 is a pressure receiving surface 304a to receive the operating force applied by the operator.

### (Moving Electrode)

The moving electrode 32 is an electrode that moves (i.e., is displaced) integrally with the operating member 30. The moving electrode 32 is made of a metal with spring characteristics and formed in a plate shape. The front surface of the moving electrode 32 is fixed onto the back surface of the substrate portion 301 of the operating member 30 via the adhesive sheet 31. The moving electrode 32 includes a body portion 321, a first connection portion 322, a second connection portion 323, and a planar portion 324. The body portion 321 is a part to face the fixed electrode 342 of the sensor board 34 and may have, for example, the shape of an annular plate with a central opening 32a. The first connection portion 322 is a part to come into contact with a reference electrode 343 of the sensor board 34. The second connection portion 323 is a part to come into contact with a switch electrode 344 of the sensor board 34. The area, facing the fixed electrode 342, of the body portion 321 serves as the planar portion 324 with a smooth flat surface.

### (Adhesive Sheet and Insulating Film)

The adhesive sheet 31 is a double-sided adhesive sheet for use to fix the moving electrode 32 to the operating member 30. The adhesive sheet 31 may have, for example, an annular sheet shape. The adhesive sheet 31 is interposed between the front surface of the body portion 321 of the moving electrode 32 and the back surface of the substrate portion 301 of the operating member 30. This allows the front surface of the moving electrode 32 (i.e., the front surface of the body portion 321) to be fixed onto the back surface of the operating member 30 (i.e., the back surface of the substrate portion 301) with the adhesive sheet 31.

The insulating film 33 is an insulating member provided to prevent the fixed electrode 342 (to be described later) of the sensor board 34 and the moving electrode 32 from being short-circuited with each other. The insulating film 33 may have, for example, an annular sheet shape. The insulating film 33 is affixed onto the fixed electrode 342 (to be described later) of the sensor board 34.

### (Sensor Board)

The sensor board 34 may be, for example, a flexible printed circuit (FPC) board. The sensor board 34 includes a board 341, a fixed electrode 342, a reference electrode 343, and a switch electrode 344. The board 341 includes a board body 3411 and an extended portion 3412. The board body 3411 may have the shape of an annular plate, for example. The board body 3411 has an opening 341a to receive the abutment portion 303. On the front surface of the board body 3411, arranged are the fixed electrode 342, the reference electrode 343, and the switch electrode 344. The extended portion 3412 is a board provided to extend a wiring electrode out of the board body (e.g., a wiring electrode from the reference electrode 343).

### (Sphere and Spring)

The sphere 36 and the spring 35 are housed in a sphere housing 372 of the first holder 37. The spring 35 is interposed between the sphere 36 and the bottom of the sphere housing 372 and biases the sphere 36 forward (i.e., toward the operating member 30). This allows the spring 35 to apply biasing force to the operating member 30 to make the planar portion 324 of the moving electrode 32 parallel to the fixed electrode 342. The sphere housing 372 allows the sphere 36 to move in the forward/backward direction (i.e., along the axis of the first holder 37) but prevents the sphere 36 from moving perpendicularly to the forward/backward direction. The spring 35 biases the sphere 36 forward to have the sphere 36 fitted into the recess 302 of the operating member 30. Fitting the sphere 36 into the recess 302 in this manner causes the operating member 30 to be biased forward by the sphere 36 biased by the spring 35. In addition, fitting the sphere 36 into the recess 302 also prevents the operating member 30 from moving (i.e., sliding) in the direction perpendicular to the forward/backward direction with respect to the first holder 37.

### (Holder)

The first holder 37 is a housing for housing the respective internal components of the input device 1 (namely, the operating member 30, the adhesive sheet 31, the moving electrode 32, the insulating film 33, the sensor board 34, the spring 35, and the sphere 36).

The first holder 37 may have, for example, a polygonal (e.g., regular octagonal) columnar shape and is made of resin. The first holder 37 includes a holder body 370, a housing recess 371, the sphere housing 372, and the step portion 373.

The holder body 370 may have, for example, a polygonal (e.g., regular octagonal) columnar shape. The front surface of the holder body 370 has the housing recess 371. In addition, the outer edges of the front surface of the holder body 370 have a plurality of screw holes 370a, into which screws N1 are screwed.

The housing recess 371 is a part that houses the above-described internal components of the input device 1 and is provided for the front surface of the holder body 370. A peripheral wall of the holder body 370 (i.e., a part that surrounds the housing recess 371) has a cutout portion 375, through which the extended portion 3412 of the sensor board 34 is extended. The internal shape of the housing recess 371 is substantially the same (e.g., regular octagonal) as the external shape of the operating member 30. This allows the housing recess 371 to house the operating member 30 non-rotatably but swingably.

The sphere housing 372 is a part that houses the sphere 36 and the spring 35. The sphere housing 372 is provided as a bottomed cylindrical hole in the central portion of the bottom surface of the housing recess 371.

The step portion 373 is a part to come into contact with the abutment portion 303 of the operating member 30. The step portion 373 is provided for the bottom surface of the housing recess 371 to surround the sphere housing 372 and may be a protrusion with an annular shape in plan view. The top surface 373a (i.e., the contact surface) of the step portion 373 is a surface to contact with the top surface (contact surface) 303a of the abutment portion 303 of the operating member 30. On the bottom surface of the housing recess 371, the area outside of the step portion 373 serves as a smooth planar portion 374, to which the sensor board 34 is affixed. The planar portion 374 is parallel to the contact surface 303a of the step portion 373.

The second holder 38 is a member that covers the flange portion 306 of the operating member 30 housed in the housing recess 371 of the first holder 37. The second holder 38 may have, for example, the shape of a polygonal flat plate and is made of a metallic material. The second holder 38 has, in the central portion thereof, an opening 38a to expose the operating portion 304 of the operating member 30. The second holder 38 is attached to the outer peripheral edge of the front surface opening of the first holder 37 with screws N2. Covering the flange portion 306 of the operating member 30 with the second holder 38 prevents the operating member 30 biased by the spring 35 from coming off the first holder 37. The second holder 38 has a plurality of screw holes 38b to pass the screws N1. The screw holes 38b are arranged along the circumference of the second holder 38.

### (2-2) Details of Sensor Board

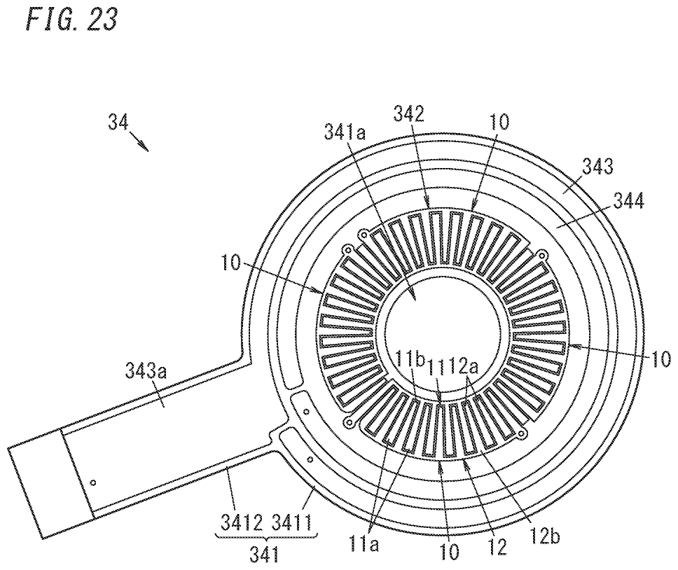

FIG. 23 is a plan view of the sensor board 34 as viewed from in front of the sensor board 34. As shown in FIG. 23, the board 341 of the sensor board 34 has an opening 341a. On the front surface of the sensor board 34 (i.e., on the front surface of the board 341), arranged are the fixed electrode 342, the reference electrode 343, and the switch electrode 344.

The fixed electrode 342 is provided on the front surface of the board 341 as a ringlike (e.g., annular) electrode surrounding the outer periphery of the opening 341a. The fixed electrode 342 has the same configuration as the fixed electrode 712 according to the first embodiment. That is to say, the fixed electrode 342 includes a plurality of (e.g., four) divided electrodes 10. Each divided electrode 10 includes a circular drive electrode 11 to be used in common and an arc-shaped reception electrode 12 to be used on an individual basis. The drive electrode 11 includes a plurality of first comb-tooth electrodes 11a and a first coupling portion 11b. Each reception electrode 12 includes a plurality of second comb-tooth electrodes 12a and a second coupling portion 12b. The plurality of second comb-tooth electrodes 12a meshes with the plurality of first comb-tooth electrodes 11a.

The switch electrode 344 is disposed on the front surface of the board 341 as a ringlike (e.g., annular) electrode outside the fixed electrode 342. The reference electrode 343 is disposed on the front surface of the board 341 as a ringlike (e.g., annular) electrode outside the switch electrode 344. The reference electrode 343 and the switch electrode 344 are arranged concentrically with the fixed electrode 342. The wiring electrode 343a of the reference electrode 343 is extended into the extended portion 3412 of the board 341.

### (2-3) Details of Moving Electrode

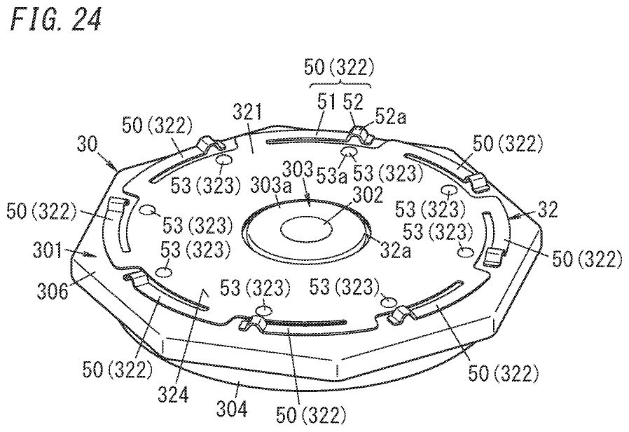

FIG. 24 is a perspective view as viewed from the backside to illustrate how the operating member 30 and the moving electrode 32 are assembled together.

The operating member 30 may have, for example, a polygonal (e.g., regular octagonal) plate shape. The back surface of the operating member 30 (i.e., the back surface of the substrate portion 301) has a recess 302 in a central portion thereof. An outer peripheral edge portion of the operating member 30 serves as the flange portion 306.

The moving electrode 32 is affixed, via the adhesive sheet 31, to the back surface of the substrate portion 301 of the operating member 30. The moving electrode 32 includes the body portion 321, the first connection portion 322, and the second connection portion 323. The body portion 321 is a part to face the fixed electrode 342 of the sensor board 34 and may have, for example, the shape of an annular plate with a central opening 32a. Inside the opening 32a, disposed is the recess 302 of the operating member 30.

The first connection portion 322 is apart to come into contact with the reference electrode 343 of the sensor board 34. The first connection portion 322 includes a plurality of (e.g., eight) brush portions 50. The plurality of brush portions 50 are arranged side by side along the circumference (i.e., on the outer periphery) of the body portion 321 to protrude along the circumference (on the outer periphery) of the body portion 321. Each brush portion 50 includes a supporting piece 51 and a protruding portion 52. The supporting piece 51 has the shape of a flat plate, which is flexible elastically, and protrudes along the circumference on the outer periphery of the body portion 321. The protruding portion 52 is a part to come into contact with the reference electrode 343 and is provided at the tip of the supporting piece 51.

The second connection portion 323 is parts to come into contact with the switch electrode 344 of the sensor board 34. The second connection portion 323 includes a plurality of (e.g., eight) projections 53. The plurality of projections 53 are arranged side by side on the outer peripheral edge of the back surface of the body portion 321. The tip surface 52a of the protruding portions 52 of the first connection portion 322 protrudes backward of the tip surface 53a of the projections 53 of the second connection portion 323.

### (2-4) Operation of Input Device

Next, it will be described with reference to FIGS. 25-28 how the input device 1 operates when the operating member 30 is subjected to a tilt operation. As shown in FIG. 25, while the input device 1 is in the standby state, the sphere 36 has been moved forward by the biasing force applied by the spring 35 and the operating member 30 has been moved forward by the sphere 36 to the point that the flange portion 306 of the operating member 30 comes into contact with the second holder 38. In this state, the first connection portion 322 of the moving electrode 32 is out of contact with the reference electrode 343 and the second connection portion 323 of the moving electrode 4 is also out of contact with the switch electrode 344. Also, the moving electrode 32 is parallel to the fixed electrode 342 of the sensor board 34. In addition, the gap S1 is left between the contact surface 303a of the abutment portion 303 of the operating member 30 and the contact surface 373a of the step portion 373 of the first holder 37.

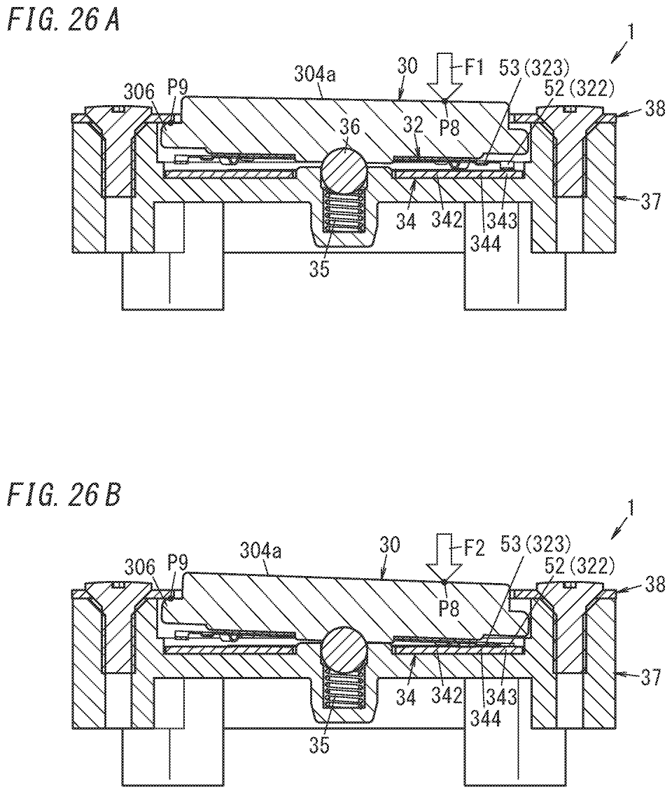

As shown in FIG. 26A, while the input device 1 is in the standby state, the operating member 30 is subjected to a tilt operation. That is to say, pressing the operating member 30 with the operating force F1 at a point (press point P8) on the outer edge of the pressure receiving surface 304a thereof causes the operating member 30 to be tilted. This state will be hereinafter referred to as a “first tilted state.” In this first tilted state, application of the operating force F1 causes the pressed part of the operating member 30 to be depressed into the first holder 37 and also causes the flange portion 306, which is located on the other side, opposite from the pressed part, of the operating member 30, to come into contact with the second holder 38 at a contact point P9. That is to say, the operating member 30 tilts on the contact point P9 as the fulcrum of tilting. This fulcrum of tilting will be hereinafter referred to as a “fulcrum of tilting P9.”

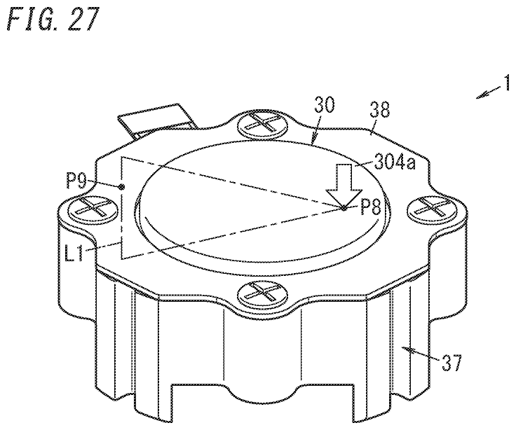

More specifically, the flange portion 306 has a polygonal (regular octagonal) external shape. Thus, as shown in FIG. 27, the flange portion 306 comes into contact with the second holder 38 on an entire one of the plurality of (e.g., eight) sides L1 of the external shape thereof. This causes the operating member 30 to be tilted on that one side L1 in contact with the second holder 38 as the tilt axis.

Referring back to FIG. 26A, in this first tilted state, tilting the operating member 30 brings the first connection portion 322 into contact with the reference electrode 343 of the sensor board 34 on the pressed side of the moving electrode 32 but the second connection portion 323 is out of contact with the switch electrode 344 of the sensor board 34.

As shown in FIG. 26B, while the input device 1 is in the first tilted state, the operating member 30 is further pressed down at the same press point P8. This state will be hereinafter referred to as a “second tilted state.” Specifically, in this second tilted state, the operating member 30 is pressed with operating force F2, which is stronger than the operating force F1, at the one point (press point P8) on the outer edge of the pressure receiving surface 304a thereof, thus causing the operating member 30 to be further tilted on the contact point P9 as the fulcrum of tilting. This brings, on the pressed side of the moving electrode 32, not just the first connection portion 322 into contact with the reference electrode 343 of the sensor board 34 but also the second connection portion 323 into contact with the switch electrode 344 as well at a time.

As can be seen, according to this embodiment, subjecting the operating member 30 to a tilt operation brings the first connection portion 322 of the moving electrode 32 into contact with the reference electrode 343 and then has the second connection portion 323 connected to the switch electrode 344 as in the first embodiment described above. Therefore, the advantages of the first embodiment are achievable in the same way according to this embodiment as well.

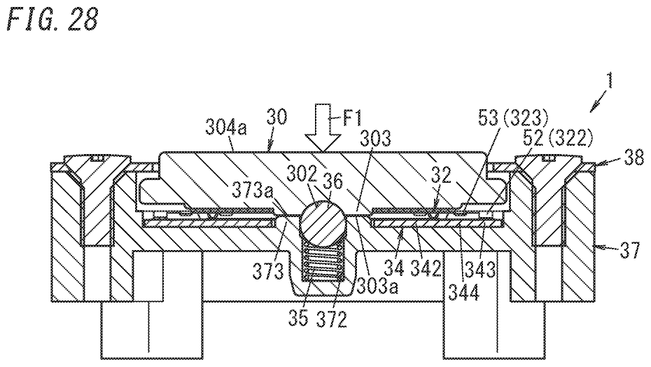

Next, it will be described with reference to FIG. 28 how the input device 1 operates when subjected to a press operation in the central portion thereof (i.e., how the input device 1 operates in the centrally pushed state). As shown in FIG. 28, when the input device 1 is in the centrally pushed state, the operating force F1 is applied to the central portion of the pressure receiving surface 304a of the operating member 30 of the input device 1. This causes the operating member 30 to be displaced in the direction in which the operating force F1 is applied, thus bringing the contact surface 303a of the abutment portion 303 of the operating member 30 into contact with the contact surface 373a of the step portion 373 of the first holder 37. In this state, the moving electrode 32 is parallel to the fixed electrode 342. In the moving electrode 32, the first connection portion 322 thereof comes into contact with the reference electrode 343 of the sensor board 34 but the second connection portion 323 thereof is out of contact with the switch electrode 344 of the sensor board 34. Such a press operation may be used as a press operation when the flick operation starts to be performed.

### (2-5) Variations

The second embodiment may be implemented in combination with the first embodiment and any of the variations thereof.

### (3) Aspects

The exemplary embodiments and their variations described above are specific implementations of the following aspects of the present disclosure.

An input device (1) according to a first aspect includes a board (711), a fixed electrode (712), a reference electrode (713), a switch electrode (714), an operating member (2), a moving electrode (4), and a holder (8). The fixed electrode (712), the reference electrode (713), and the switch electrode (714) are provided for the board (711). The operating member (2) is arranged to face the board (711) and is vertically movable and tiltable with respect to the board (711) when subjected to a press operation. The moving electrode (4) is provided for the operating member (2) and is movable integrally with the operating member (2). The moving electrode (4) includes a first connection portion (42) and a second connection portion (43). The first connection portion (42) is arranged to face the reference electrode (713). The second connection portion (43) is arranged to face the switch electrode (714). The board (711) is placed in the holder (8). Subjecting the operating member (2) to no press operation keeps the moving electrode (4) out of contact with the fixed electrode (712), the reference electrode (713), or the switch electrode (714). Subjecting the operating member (2) to a press operation brings the first connection portion (42) into contact with the reference electrode (713) and then brings the second connection portion (43) into contact with the switch electrode (714).

According to this configuration, when the operating member (2) is subjected to a press operation, first, the first connection portion (42) comes into contact with the reference electrode (713) to change the potential at the moving electrode (4) into a reference potential. This causes the capacitance of the fixed electrode (712) to change, thus making the operation performed on the operating member (2) detectible. Thereafter, when the operating member (2) is further pressed down, the second connection portion (43) comes into contact with the switch electrode (714) to change the potential at the switch electrode (714) into the reference potential via the moving electrode (4). When the potential at the switch electrode (714) changes into the reference potential in this manner, detection is made that the operating member (2) has tilted to a predetermined tilt angle. This enables determining whether the operation has been detected in a range where the operating member (2) is tilted to an angle equal to or greater than a predetermined tilt angle. In addition, the operation may be detected in not only a range where the tilt angle of the operating member (2) is equal to or greater than the predetermined tilt angle as described above but also a range where the tilt angle of the operating member (2) is less than the predetermined tilt angle. Thus, the operation is detectible even when the tilt angle of the operating member (2) falls within a broader range. Consequently, the operation is detectible even when the tilt angle of the operating member (2) falls within a broader range. Besides, a determination may also be made whether the operation has been detected in a range where the tilt angle of the operating member (2) is equal to or greater than the predetermined tilt angle.

In an input device (1) according to a second aspect, which may be implemented in conjunction with the first aspect, the operating member (2) includes an abutment portion (22) disposed on a surface, facing either the board (711) or the holder (8), of the operating member (2). Subjecting the operating member (2) to a tilt operation brings the abutment portion (22) into contact with either the holder (8) or the board (711) and thereby causes the operating member (2) to be tilted on the abutment portion (22) serving as a fulcrum of tilting.

According to this configuration, when the operating member (2) is subjected to a tilt operation, the abutment portion (22) comes into contact with either the holder (8) or the board (711) to cause the operating member (2) to be tilted on the abutment portion (22) serving as a fulcrum. This allows the tilting movement of the operating member (2) to be stabilized.

In an input device (1) according to a third aspect, which may be implemented in conjunction with the first or second aspect, the fixed electrode (712) includes a plurality of divided electrodes (10) arranged in a ring.

This configuration makes the tilt direction (θ) of the operating member (2) easily detectible. As used herein, the “tilt direction (θ)” of the operating member (2) refers to a direction defined around the center of the fixed electrode (712) by the tilt caused to the operating member (2) by the tilt operation.

In an input device (1) according to a fourth aspect, which may be implemented in conjunction with the third aspect, each of the reference electrode (713) and the switch electrode (714) has a shape of a ring concentric with the fixed electrode (712).

This configuration allows the timings when the moving electrode (4) comes into contact with the reference electrode (713) and the switch electrode (714) to be stabilized irrespective of the tilt direction (θ) of the operating member (2).

In an input device (1) according to a fifth aspect, which may be implemented in conjunction with the third or fourth aspect, each of the plurality of divided electrodes (10) includes a ringlike drive electrode (11) and a reception electrode (12). The drive electrode (11) is used in common between the plurality of divided electrodes (10) and includes a plurality of first comb-tooth electrodes (11a). The reception electrode (12) includes a plurality of second comb-tooth electrodes (12a) meshing with the plurality of first comb-tooth electrodes (11a). The respective reception electrodes (12) of the plurality of divided electrodes (10) are arranged side by side along a circumference of the drive electrode (11).

According to this configuration, each of the plurality of divided electrodes (10) includes: a drive electrode (11) including a plurality of first comb-tooth electrodes (11a); and a reception electrode (12) having a plurality of second comb-tooth electrodes (12a) meshing with the plurality of first comb-tooth electrodes (11a). This enables reducing the effect of noise when the capacitance between the moving electrode (4) and the fixed electrode (712) (i.e., the plurality of divided electrodes (10)) is detected. In addition, this also allows divided electrodes (10) for use to detect the operation to be selected by controlling the drive electrode (11). For example, all the divided electrodes (10) are used to detect the tilt direction (θ). On the other hand, to detect a slide operation, only two divided electrodes (10) located on a slide movement line are used, thereby allowing the operation to be detected more quickly.

In an input device (1) according to a sixth aspect, which may be implemented in conjunction with any one of the first to fifth aspects, the first connection portion (42) protrudes farther toward the board (711) than the second connection portion (43) does.

This configuration enables, when the operating member (2) is subjected to a press operation, easily bringing the first connection portion (42) into contact with the reference electrode (713) first and then bringing the second connection portion (43) into contact with the switch electrode (714).

In an input device (1) according to a seventh aspect, which may be implemented in conjunction with the second aspect, unless the operating member (2) is operated, a gap (S1) is left between a contact surface (22a) of the abutment portion (22) and one member facing the contact surface (22a) which is selected from the group consisting of the board (711) and the holder (8).

This configuration allows, when the operating member (2) is subjected to a press operation, the operating member (2) to be displaced toward the board (711) by narrowing the gap (S1) left between the contact surface (22a) of the abutment portion (22) and either the board (711) or the holder (8) which faces the contact surface (22a). This makes the operating member (2) displaceable toward the board (711) when a press operation is performed on the pressure receiving surface (21a) of the operating member (2) on a central portion thereof.

In an input device (1) according to an eighth aspect, which may be implemented in conjunction with the seventh aspect, the contact surface (22a) of the abutment portion (22) is a flat surface. The first connection portion (42) of the moving electrode (11) is elastically flexible. When the contact surface (22a) of the abutment portion (22) of the operating member (2) makes plane contact with either the board (711) or the holder (8) as the one member facing the contact surface (22a), the first connection portion (42) is in contact with the reference electrode (713) and the second connection portion (43) is out of contact with the switch electrode (714).

According to this configuration, when a central portion of an operating surface (523) of an operating button (520) is touched (i.e., lightly pressed) to perform a flick operation, for example, the operating member (2) is pressed down perpendicularly to the board (711) to bring the flat contact surface (22a) of the abutment portion (22) of the operating member (2) into plane contact with either the board (711) or the holder (8). This allows the operating member (2) to maintain its orientation so that the moving electrode (11) and the fixed electrode (712) are parallel to each other. At this time, the first connection portion (42) is flexed to come into contact with the reference electrode (713), thus causing the moving electrode (4) to have a reference potential and thereby making a touch operating state of the operating button (520) detectible based on the capacitance of the fixed electrode (712). This allows the state of a central touch (i.e., the state of a predictive text input screen G1 for a flick operation) to be stabilized at the start of the flick operation, i.e., before the operating member (2) is tilted by shifting a press point, where operating force is applied on the pressure receiving surface (21a) of the operating member (2), from the central portion toward a certain point on the outer edge.

In an input device (1) according to a ninth aspect, which may be implemented in conjunction with the second aspect, the abutment portion (22) has a contact surface (22a) having a circular external shape. Subjecting the operating member (2) to a press operation brings the contact surface (22a) into contact with either the holder (8) or the board (711). Further subjecting the operating member (2) to a tilt operation causes the operating member (2) to be tilted on a predetermined tilt axis (A1). When the input device (1) is viewed in plan in a direction (D1) perpendicular to the board (711), the predetermined tilt axis (A1) is a tangential line drawn to pass through an intersection (P1) on a contour (22b) of the contact surface (22a), where the intersection (P1) is a point where a virtual line (L2) that connects a press point (P2), where the press operation is performed on the operating member (2), to a center (P3) of a pressure receiving surface (21a) of the operating member (2) and the contour (22b) of the contact surface (22a) intersect with each other.

According to this configuration, when a press operation is performed on the operating member (2), the contact surface (22a) of the abutment portion (22) comes into plane contact with either the board (711) or the holder (8). This enables stabilizing the orientation of the operating member (2) subjected to the press operation. Also, supposing a point where a virtual line (L2) that connects a press point (P2), where the press operation is performed on the operating member (2), to a center (P3) of the operating member (2) and the contour (22b) of the contact surface (22a) intersect with each other is an intersection (P1), the predetermined tilt axis (A1) on which the operating member (2) is tilted is a tangential line drawn to pass through the intersection (P1) on the contour (22b) of the contact surface (22a) of the abutment portion (22). This allows, when the operating member (2) is subjected to the press operation, the operating member (2) to be tilted toward a direction pointing to the press point (P2).

In an input device (1) according to a tenth aspect, which may be implemented in conjunction with the second aspect, the abutment portion (22) has a contact surface (22a), of which an external shape is a shape of a polygon having a plurality of sides (M1). Subjecting the operating member (2) to a tilt operation causes the operating member (2) to be tilted on a tilt axis defined by one of the plurality of sides (M1) of the contact surface (22a).

This configuration allows, when the operating member (2) is subjected to atilt operation, the tilt direction (θ) of the operating member (2) to be limited to a direction perpendicular to one of a plurality of sides (M1) of the contact surface (22a) of the abutment portion (22).

In an input device (1) according to an eleventh aspect, which may be implemented in conjunction with the tenth aspect, the fixed electrode (712) includes a plurality of divided electrodes (10) arranged in a ring. When the input device (1) is viewed in plan in a direction perpendicular to the board (711), a bisector (L4) that evenly divides, into two, a width (W1) of each of the plurality of divided electrodes also evenly divides, into two, one of the plurality of sides (M1) that forms the external shape of the abutment portion (22).

This configuration allows detection of the tilt direction (θ) of the operating member (2) to be stabilized.

In an input device (1) according to a twelfth aspect, which may be implemented in conjunction with the second aspect, the abutment portion (22) has a contact surface (22a) as a convex curved surface. Applying pressing force to the operating member (2) causes the operating member (2) to be tilted on a fulcrum of tilting defined by a contact point (P6) between the convex curved surface of the abutment portion (22) and either the board (711) or the holder (8). As a press point (P5), where the pressing force is applied to the operating member (2), shifts on the operating member (2), the fulcrum of tilting (P6) also shifts on the convex curved surface (22a).

According to this configuration, the contact surface (22a) of the abutment portion (22) is a convex curved surface. Thus, as the press point (P5) shifts, the fulcrum of tilting (P6) also shifts, thus causing the operating member (2) to smoothly change its tilt angle accordingly. As a result, as the press point (P5) shifts, the capacitance of the fixed electrode (712) changes smoothly. This allows, when the operating member (2) is subjected to an operation of linearly shifting the press point (P5) on the operating member (2) (e.g., a slide operation), the shift of the press point (P5) to be detected continuously.

In an input device (1) according to a thirteenth aspect, which may be implemented in conjunction with any one of the first to twelfth aspects, the moving electrode (4) is made of an elastic material having electrical conductivity. The moving electrode (4) includes a planar portion (45), the first connection portion (42), the second connection portion (43), and a flexible portion (44). The planar portion (45) is arranged to face the fixed electrode (712). The first connection portion (42) is arranged to face the reference electrode (713). The second connection portion (43) is arranged to face the switch electrode (714). The flexible portion (44) is arranged to come into contact with the board (711). The flexible portion (44) maintains an orientation of the operating member (2) to make the planar portion (45) parallel to the fixed electrode (712) unless the operating member (2) is operated. The flexible portion (44) applies biasing force to the operating member (2) to make the planar portion (45) parallel to the fixed electrode (712) again when the operating member (2) is operated.

This configuration allows a single member to serve as a means for maintaining the orientation of the moving electrode (4) in a standby state, a means for recovering the orientation of the operating member (2) that has been tilted, a means for bringing the moving electrode (4) into contact with the reference electrode (713), and a means for bringing the moving electrode (4) into contact with the switch electrode (714). This enables downsizing the input device (1).

An input device (1) according to a fourteenth aspect, which may be implemented in conjunction with any one of the first to twelfth aspects, further includes a spring (35) that applies biasing force to the operating member (2). In the input device (1), the moving electrode (32) is made of an elastic material having electrical conductivity. The moving electrode (32) includes a planar portion (324), a first connection portion (322), and a second connection portion (323). The planar portion (324) is arranged to face the fixed electrode (342). The first connection portion (42) is arranged to face the reference electrode (343). The second connection portion (43) is arranged to face the switch electrode (344). The spring (35) applies biasing force to the operating member (30) to make the planar portion (324) parallel to the fixed electrode (342).

This configuration allows a single member to serve as a means for bringing the moving electrode (32) into contact with the reference electrode (343) and a means for bringing the moving electrode (32) into contact with the switch electrode (344). This enables downsizing the input device (1).

In an input device (1) according to a fifteenth aspect, which may be implemented in conjunction with any one of the first to fourteenth aspects, the operating member (2) has an external shape of a polygon having a plurality of sides (L1). Subjecting the operating member (2) to a tilt operation brings one of the plurality of sides (L1) that form the external shape of the operating member (2) into contact with either the board (711) or the holder (8).

This configuration allows the tilt direction (θ) of the operating member (2) subjected to a tilt operation to be limited to a direction perpendicular to the one side. In this case, the tilt direction (0) of the operating member (2) is limited to such a direction perpendicular to one side (L1) of the polygon that defines the external shape of the operating member (2). This limitation makes it easier for the operator to select his or her desired tilt direction (θ) accurately even without looking at the operating member (2).

In an input device (1) according to a sixteenth aspect, which may be implemented in conjunction with the fifteenth aspect, the fixed electrode (712) includes a plurality of divided electrodes (10) arranged in a ring. When the input device (1) is viewed in plan in a direction perpendicular to the board (711), a bisector (L4) that evenly divides, into two, the width (W1) of each of the plurality of divided electrodes (10) also evenly divides, into two, one of the plurality of sides (L1) that form the external shape of the operating member (2).

This configuration allows detection of the tilt direction (θ) of the operating member (2) to be stabilized.

In an input device (1) according to a seventeenth aspect, which may be implemented in conjunction with any one of the first to fourteenth aspects, the operating member (2) includes a plurality of projections (27) arranged along a peripheral edge of the surface, facing either the board (711) or the holder (8), of the operating member (2). Subjecting the operating member (2) to atilt operation brings two adjacent projections (27), belonging to the plurality of projections (27), into contact with either the holder (8) or the board (711).

This configuration allows the tilt direction (θ) of the operating member (2) subjected to a tilt operation to be limited to a direction intersecting at right angles with a line segment that connects the two adjacent projections (27) together. In that case, the tilt direction (θ) of the operating member (2) is limited to such a direction intersecting at right angles with the line segment that connects together the two adjacent projections (27) out of the plurality of projections (27). This limitation makes it easier for the operator to select his or her desired tilt direction (θ) accurately even without looking at the operating member (2).

In an input device (1) according to an eighteenth aspect, which may be implemented in conjunction with the seventeenth aspect, the fixed electrode (712) includes a plurality of divided electrodes (10) arranged in a ring. When the input device (1) is viewed in plan in a direction perpendicular to the board (711), a virtual line that evenly divides, into two, the width (W1) of each of the plurality of divided electrodes (10) also evenly divides, into two, a line segment that connects together the two adjacent projections (27) belonging to the plurality of projections (27).

This configuration allows detection of the tilt direction (θ) of the operating member (2) to be stabilized.

In an input device (1) according to a nineteenth aspect, which may be implemented in conjunction with any one of the first to eighteenth aspects, the operating member (2) accepts at least one operation selected from the group consisting of a flick operation, a rotary operation, a swipe operation, and a slide operation. The flick operation is an operation of pressing a pressure receiving surface (21a) of the operating member (2) in a central portion thereof to cause a press point to shift from the central portion toward a point on an outer edge. The rotary operation is an operation of pressing the pressure receiving surface (21a) of the operating member (2) at an arbitrary point on the outer edge to cause the press point to shift from the arbitrary point circularly along the outer edge. The swipe operation is an operation of pressing the pressure receiving surface (21a) of the operating member (2) at an arbitrary point on the outer edge to cause the press point to shift linearly to a point, opposite from the arbitrary point, on the outer edge. The slide operation is an operation of pressing the pressure receiving surface (21a) of the operating member (2) at an arbitrary point to cause the press point to shift linearly through a center of the pressure receiving surface (21a).

This configuration allows the operating member (2) to accept at least one operation selected from the group consisting of the flick operation, the rotary operation, the swipe operation, and the slide operation.

An assembled device (500) according to a twentieth aspect includes the input device (1) according to any one of the first to nineteenth aspects, a rubber sheet (510), an operating button (520), a base (530), and a cover panel (540). The rubber sheet (510) is disposed forward of the operating member (2; 30) of the input device (1). The operating button (520) is disposed forward of the rubber sheet (510). The base (530) has a housing recess (533) to house the input device (1), the rubber sheet (510), and the operating button (520). The cover panel (540) has an opening (541) to expose the operating button (520) and is attached to a front surface of the base (530) with the input device (1), the rubber sheet (510), and the operating button (520) housed in the housing recess (533).

This configuration enables providing an assembled device (500) including the input device (1) that achieves the above-described advantages.

### REFERENCE SIGNS LIST

1 Input Device
2, 30 Operating Member
4, 32 Moving Electrode
8 Holder
10 Divided Electrode
11 Drive Electrode
11a First Comb-Tooth Electrode
12 Reception Electrode
12a Second Comb-Tooth Electrode
21a, 304a Pressure Receiving Surface
22 Protrusion (Abutment Portion)
22a Contact Surface
22b Contour
27 Projection
35 Spring
42, 322 First Connection Portion
43, 323 Second Connection Portion
44 Flexible Portion
45, 324 Planar Portion
342, 712 Fixed Electrode
343, 713 Reference Electrode
344, 714 Switch Electrode
434 Reference Electrode
500 Assembled Device
510 Rubber Sheet
520 Operating Button
530 Base
533 Housing Recess
540 Cover Panel
541 Opening
711 Board
A1 Tilt Axis
L1 Side
L2 Virtual Line
L4 Bisector
M1 Side
P1 Intersection
P2 Press Point
P3 Center
P5 Press Point
P6 Contact Point (Fulcrum of Tilting)
S1 Gap
θ Tilt Direction

1. An input device comprising:
a board;
a fixed electrode, a reference electrode, and a switch electrode, all of which provided for the board;
an operating member arranged to face the board and configured to be vertically movable and tiltable with respect to the board when subjected to a press operation;
a moving electrode provided for the operating member and configured to be movable integrally with the operating member; and
a holder in which the board is placed,
the moving electrode including: a first connection portion arranged to face the reference electrode; and a second connection portion arranged to face the switch electrode,
subjecting the operating member to no press operation keeping the moving electrode out of contact with the fixed electrode, the reference electrode, or the switch electrode, and
subjecting the operating member to a press operation bringing the first connection portion into contact with the reference electrode and then bringing the second connection portion into contact with the switch electrode.

2. The input device of claim 1, wherein
the operating member includes an abutment portion disposed on a surface, facing either the board or the holder, of the operating member, and
subjecting the operating member to a tilt operation brings the abutment portion into contact with either the holder or the board and thereby causes the operating member to be tilted on the abutment portion serving as a fulcrum of tilting.

3. The input device of claim 1, wherein
the fixed electrode includes a plurality of divided electrodes arranged in a ring.

4. The input device of claim 3, wherein
each of the reference electrode and the switch electrode has a shape of a ring concentric with the fixed electrode.

5. The input device of claim 3, wherein
each of the plurality of divided electrodes includes:
a ringlike drive electrode used in common between the plurality of divided electrodes and including a plurality of first comb-tooth electrodes; and
a reception electrode including a plurality of second comb-tooth electrodes meshing with the plurality of first comb-tooth electrodes, and
the respective reception electrodes of the plurality of divided electrodes are arranged side by side along a circumference of the drive electrode.

6. The input device of claim 1, wherein
the first connection portion protrudes farther toward the board than the second connection portion does.

7. The input device of claim 2, wherein
unless the operating member is operated, a gap is left between a contact surface of the abutment portion and one member facing the contact surface which is selected from the group consisting of the board and the holder.

8. The input device of claim 7, wherein
the contact surface of the abutment portion is a flat surface,
the first connection portion of the moving electrode is elastically flexible, and
when the contact surface of the abutment portion of the operating member makes plane contact with either the board or the holder as the one member facing the contact surface, the first connection portion is in contact with the reference electrode and the second connection portion is out of contact with the switch electrode.

9. The input device of claim 2, wherein
the abutment portion has a contact surface having a circular external shape,
subjecting the operating member to a press operation brings the contact surface into contact with either the holder or the board,
further subjecting the operating member to a tilt operation causes the operating member to be tilted on a predetermined tilt axis, and
when the input device is viewed in plan in a direction perpendicular to the board, the predetermined tilt axis is a tangential line drawn to pass through an intersection on a contour of the contact surface, where the intersection is a point where a virtual line that connects a press point, where the press operation is performed on the operating member, to a center of a pressure receiving surface of the operating member and the contour of the contact surface intersect with each other.

10. The input device of claim 2, wherein
the abutment portion has a contact surface, of which an external shape is a shape of a polygon having a plurality of sides, and
subjecting the operating member to a tilt operation causes the operating member to be tilted on a tilt axis defined by one of the plurality of sides of the contact surface.

11. The input device of claim 10, wherein
the fixed electrode includes a plurality of divided electrodes arranged in a ring, and
when the input device is viewed in plan in a direction perpendicular to the board, a bisector that evenly divides, into two, a width of each of the plurality of divided electrodes also evenly divides, into two, one of the plurality of sides that forms the external shape of the abutment portion.

12. The input device of claim 2, wherein
the abutment portion has a contact surface as a convex curved surface,
applying pressing force to the operating member causes the operating member to be tilted on a fulcrum of tilting defined by a contact point between the convex curved surface of the abutment portion and either the board or the holder, and
as a press point, where the pressing force is applied to the operating member, shifts on the operating member, the fulcrum of tilting also shifts on the convex curved surface.

13. The input device of claim 1, wherein
the moving electrode is made of an elastic material having electrical conductivity,
the moving electrode includes:
a planar portion arranged to face the fixed electrode;
the first connection portion arranged to face the reference electrode;
the second connection portion arranged to face the switch electrode; and
a flexible portion arranged to come into contact with the board, and
the flexible portion is configured to maintain an orientation of the operating member to make the planar portion parallel to the fixed electrode unless the operating member is operated and to apply biasing force to the operating member to make the planar portion parallel to the fixed electrode again when the operating member is operated.

14. The input device of claim 1, further comprising a spring that applies biasing force to the operating member, wherein
the moving electrode is made of an elastic material having electrical conductivity,
the moving electrode includes:
a planar portion arranged to face the fixed electrode;
the first connection portion arranged to face the reference electrode; and
the second connection portion arranged to face the switch electrode, and
the spring applies the biasing force to the operating member to make the planar portion parallel to the fixed electrode.

15. The input device of claim 1, wherein
the operating member has an external shape of a polygon having a plurality of sides, and
subjecting the operating member to a tilt operation brings one of the plurality of sides that form the external shape of the operating member into contact with either the board or the holder.

16. The input device of claim 15, wherein
the fixed electrode includes a plurality of divided electrodes arranged in a ring, and
when the input device is viewed in plan in a direction perpendicular to the board, a bisector that evenly divides, into two, a width of each of the plurality of divided electrodes also evenly divides, into two, one of the plurality of sides that form the external shape of the operating member.

17. The input device of claim 1, wherein
the operating member includes a plurality of projections arranged along a peripheral edge of the surface, facing either the board or the holder, of the operating member, and
subjecting the operating member to a tilt operation brings two adjacent projections, belonging to the plurality of projections, into contact with either the holder or the board.

18. The input device of claim 17, wherein
the fixed electrode includes a plurality of divided electrodes arranged in a ring, and
when the input device is viewed in plan in a direction perpendicular to the board, a virtual line that evenly divides, into two, a width of each of the plurality of divided electrodes also evenly divides, into two, a line segment that connects together the two adjacent projections belonging to the plurality of projections.

19. The input device of claim 1, wherein
the operating member is configured to accept at least one operation selected from the group consisting of a flick operation, a rotary operation, a swipe operation, and a slide operation,
the flick operation is an operation of pressing a pressure receiving surface of the operating member in a central portion thereof to cause a press point to shift from the central portion toward a point on an outer edge,
the rotary operation is an operation of pressing the pressure receiving surface of the operating member at an arbitrary point on the outer edge to cause the press point to shift from the arbitrary point circularly along the outer edge,
the swipe operation is an operation of pressing the pressure receiving surface of the operating member at an arbitrary point on the outer edge to cause the press point to shift linearly to a point, opposite from the arbitrary point, on the outer edge, and
the slide operation is an operation of pressing the pressure receiving surface of the operating member at an arbitrary point to cause the press point to shift linearly through a center of the pressure receiving surface.

20. An assembled device comprising:
the input device of claim 1;
a rubber sheet disposed forward of the operating member of the input device;
an operating button disposed forward of the rubber sheet;
a base having a housing recess to house the input device, the rubber sheet, and the operating button; and
a cover panel having an opening to expose the operating button and attached to a front surface of the base with the input device, the rubber sheet, and the operating button housed in the housing recess.
